(19) United States
(12) Patent Application Publication
(10) Pub. No.: US 2025/0140275 A1
(43) Pub. Date: May 1, 2025

(54) Whispered and Other Low Signal-to-Noise Voice Recognition Systems and Methods

(71) Applicant: Skywalk Inc., Palo Alto, CA (US)

(72) Inventors: Tyler Nai Ming Chen, Carlsbad, CA (US); Savannah Ashley Cofer, Lewis Center, OH (US); Bingyi Wang, Palo Alto, CA (US); Junrui Yang, Hayward, CA (US)

(21) Appl. No.: 18/929,173

(22) Filed: Oct. 28, 2024

Related U.S. Application Data
(60) Provisional application No. 63/594,215, filed on Oct. 30, 2023.

(51) Int. Cl. G10L 21/0232; G10L 21/0216; G10L 25/30; H04R 1/10

(52) U.S. Cl. CPC G10L 21/0232; G10L 25/30; G10L 2021/02166; H04R 1/1016; H04R 1/1075; H04R 2460/13

(57) ABSTRACT

Methods and systems capture sounds on multiple sensors of a device worn by a user to produce streams of audio signals as preliminary audio output, transform the streams of audio signals and extract features from a resulting transform of the audio signals, and denoise the preliminary audio output by inputting the extracted features to a statistical model or neural network. As a result, a processed signal having a higher SNR than the preliminary audio output is produced. A humanly perceptible output in the form of transcribed text or a voiced version of the user' speech may be generated from the processed signal. The wearable device may be an earbud having microphones dedicated to capture sound conducted through air in an environment in which the user is situated and speech of the user conducted through bone of the user to one of the sensors.

### CROSS-REFERENCE TO RELATED APPLICATIONS

The present application is related to and claims priority benefit of U.S. provisional application No. 63/594,215 filed Oct. 30, 2023.

### BACKGROUND

The present technology relates to speech recognition and in a basic sense relates to the extraction of a user's speech when present in audio having a low signal-to-noise ratio (SNR). In particular, the present technology relates to systems for and methods of generating audio or text from speech. The systems and methods may be used for dictation. The systems and methods may be used to form commands suited for acquisition and use by voice-activated assistants, namely, virtual or AI assistants.

Dictation is the action of saying words, usually out loud, to be recorded in some form for later reference. Application programs that understand voice commands of a user and complete tasks based on the commands are referred to as voice-activated assistants, and sometimes as virtual or AI assistants or agents. Conducting dictation under some conditions may be challenging or pose privacy and security concerns. Likewise, generating commands suited for acquisition and use by voice-activated assistants in conventional ways is subject to various drawbacks and pose many challenges especially under certain conditions and in certain environments.

### SUMMARY

One object of the present technology is to provide methods and systems by which dictation can be carried out in environments and/or conditions in which captured audio, including the voice of the person conducting the dictation, has a low signal-to-noise ratio (SNR).

Another object of the present technology is to provide methods and systems capable of discerning a user's speech when the speech is uttered in a way or in an environment in which the speech cannot be heard by a listener situated close to the speaker.

Still another object of the present technology is to provide speech recognition methods and systems capable of forming voice commands which free an end user from being tied to a desk and are intuitive and otherwise easy to use.

Another object of the present technology is to provide speech recognition methods and systems that generate voice commands by which an end user can command a voice-activated assistant to augment their workflow, instead of merely automating it.

Still another object of the present technology is to provide speech recognition methods and systems that facilitate the creation of personalized voice commands.

Still another object of the present technology is to provide methods and systems that reproduce a user's speech, in a humanly perceptible form, or generate voice commands in private and hence, in a secure and imperceptible manner.

Still another object of the present technology is to provide speech recognition methods and systems that generate voice commands (text or audio) suitable for input to a virtual or AI assistant.

Another object of the present technology is to provide a system of and method by which speech can be captured by an innocuous or unobtrusive wearable device and then discerned. The speech can be virtually any “inaudible” speech, i.e., speech that has a low signal-to-noise ratio. One way such speech can be determined as speech that has a low signal-to-noise ratio, is when the mean energy level of the speech is below the level of noise measured just outside the speaker's ear. For example, “inaudible” speech can be in the form of whispers in a quiet environment or even voiced speech in a loud environment such as at a construction site or loud concert.

According to one aspect of the present technology, there is provided a method of discerning and reproducing speech, comprising: separately capturing sound conducted through air in an environment in which the user is situated, and through bone of a user while the user is speaking to produce, as a preliminary audio output, channels of streams of audio signals, transforming the streams of audio signals constituting the preliminary audio output and extracting features from a resulting transform of the audio signals, denoising the preliminary audio output to produce a processed signal, and generating humanly perceptible output, which expresses the speech of the user, from the processed signal. The denoising comprises inputting the extracted features to a statistical model or a neural network. The preliminary audio output has a low signal-to-noise ratio (SNR) and as a result of the denoising, the processed signal has a higher SNR than the preliminary audio output.

According to another aspect of the present technology, there is provided a method of discerning and reproducing speech, comprising: capturing sounds on multiple sensors of a device worn by a user while the user is speaking and wherein the sounds include sound conducted through air in an environment in which the user is situated and speech of the user conducted through bone of the user to one of the sensors, producing, as a preliminary audio output, channels of streams of audio signals, transforming the streams of audio signals constituting the preliminary audio output and extracting features from a resulting transform of the audio signals, denoising the preliminary audio output to produce a processed signal, and generating humanly perceptible output, which expresses the speech of the user, from the processed signal. The denoising comprises inputting the extracted features to a statistical model or a neural network. The preliminary audio output has a low signal-to-noise ratio (SNR) and, as a result of the denoising, the processed signal has a higher SNR than the preliminary audio output.

According to still another aspect of the present technology, there is provided a system for use in discerning and reproducing speech, comprising: multiple sensors constituting a wearable device and operative to capture sounds including sound conducted through air in an environment in which a user wearing the device is situated and speech of the user conducted through bone of the user to one of the sensors, and a computer system configured to receive the channels of audio signals from the wearable device. The sensors are operative to produce, as a preliminary audio output, channels of streams of audio signals, and wherein the preliminary audio output has a low signal-to-noise ratio (SNR). The computer system comprises a processing unit, and non-transitory computer-readable media (CRM) storing operating instructions. The processing unit has a denoising module comprising a statistical model or a neural network and is configured to execute the operating instructions to transform the streams of audio signals constituting the preliminary audio output and extract features from a resulting transform of the audio signals, and denoise the preliminary audio output to produce a processed signal having a higher SNR than the preliminary audio output. The denoising comprises inputting the extracted features to the statistical model or neural network.

In some examples, the wearable device is an occluded-ear earbud. The sensors are multiple microphones of the earbud which capture sounds including speech with high fidelity. The computing system may be constituted by an on-board microprocessor unit (MPU). The computing system denoises the sounds with neural network architecture, inputs denoised speech to a custom trained speech-to-text neural network and generates a transcribed version (text) of the user's whispered speech. The text may then be used for input into another AI model, outputted as dictated text, saved to a database, etc.

In one configuration, the (MPU of the) earbud runs a voice activity detection and denoising/compression algorithm, then transmits the denoised/compressed signal over Bluetooth to a local device, which runs a speech-to-text neural net to generate text output.

In another configuration, the (MPU of the) earbud runs a voice activity detection and denoising/compression algorithm, then transmits the denoised/compressed signal over Bluetooth to a local device, which runs a speech-to-text neural net to generate text output, which transmits the text output over Bluetooth back to the earbud, which transmits the text output over Bluetooth back to the local device using a Bluetooth keyboard specification.

In still another configuration, the earbud runs the voice activity detection and denoising/compression algorithm, then transmits the denoised/compressed signal over Bluetooth to a local device, which transmits the signal over a wireless cellular network such as Wi-Fi or LTE to the cloud, which runs a speech-to-text neural net to generate a text output which is sent back to the local device.

In some examples, the text output is passed into a large language model in the cloud. In other examples, voiced speech expressing the speech represented by the denoised/compressed signal is generated instead of text. The voiced speech may be in the voice of the user.

In one particular example of the present technology, the earbud is provided with an in-ear microphone and environmental and talk microphones. The in-ear microphone is used to record primarily bone-conducted speech data with some small amount of background noise (suppressed due to the microphone's isolation from the environment). Simultaneously, the environmental and talk microphones are used to record primarily background noise with some small amount of speech data. The earbud may be provided with one or more alternative forms of a sensor to a microphone to record other aspects of the sound. For example, an inertial sensor operating at a fairly high frequency, namely an inertial measurement unit (IMU), may be provided to detect vocal cord vibrations conducted through the user's tissue.

By fusing these sensor streams, a low-SNR speech signal can be captured and amplified from (primarily) the in-ear microphone while denoising this signal by rejecting the measured noise from the other sensors.

Producing a humanly audible or readable output of the user's speech is a challenge partially due to the difference in frequency content for bone-conducted speech, which is less affected by external noise but contains less high-frequency information compared to air-conducted speech. A user may also prefer for their voice to come across as audible voiced speech even though they are whispering so quietly that others cannot hear, which presents another challenge. In one example, the bone-conduction frequency shift is resolved using bandwidth extension techniques on the denoised speech data, and the whispered vs. voiced speech issue is resolved with a neural network as a filter. Alternatively, the denoised speech is output to a custom-trained speech-to-text neural network which has been trained to have high performance on whispered and bone-conducted speech, converting to text with high accuracy. This allows the end user to speak inaudibly with an AI agent—quietly enough that the nearest observer is unable to hear and discern their words.

A whispered voice recognition method according to the present technology may be predicated on predetermined information as to how the in-ear, environmental, and talk microphones' signals (and any inertial sensors' signal) should appear for whispered speech, voiced speech, or ambient background noise. The information may include how well the earbud is sealed to the user's ear.

The recording of data can be initiated with or without a trigger.

From the predetermined information and the recorded data from the different sensors (microphones or other form(s) of audio sensors), the whispered voice recognition technology is configured to execute/executes a process of producing an intermediate output—for example, a classification of whether the user was speaking at a whisper, or was speaking with a loud voice, background noise, breathing, in a lull between breaths, etc. The intermediate output may also cause an updating of the predetermined information based on measured transfer functions between the in-ear microphone and out-of-ear microphone, for example. The intermediate output may also cause modifications to the signal, e.g., signal ducking in certain frequency bands of a signal channel or ducking of an audio output from a speaker. The intermediate output may also be used as a trigger, e.g., trigger further signal processing if a determination is made that the user was speaking at a whisper. The further processing creates a denoised signal from the multiple sensors (microphones and other type of sensor(s)). This denoised signal may be compressed compared to the original multichannel audio input (which helps for data transmission) and may have an amplified speech band. The denoised signal may also have some frequency modifications to make it easier for a speech-to-text model (or a human) to interpret. The denoised signal may be then transmitted to a custom speech-to-text model for conversion to text. The speech-to-text model may be explicitly selected as a whispered vs. voiced speech model per the earlier classification, or the earlier output may be fed in as an input to the model (implicit selection). As such, a system which ignores commands issued by a user using voiced speech, but is responsive to commands issued in a whispered tone of voice can be realized according to the present technology.

There are also provided, according to the present technology, examples adapted to recognize speech other than just whispered speech, such as voiced speech in environments in which loud background noise is present, with one or more of the features and attendant advantages mentioned above.

### BRIEF DESCRIPTION OF THE DRAWINGS

These and other objects, features and advantages of the present technology will be better understood from the detailed description of preferred embodiments and examples thereof that follows with reference to the accompanying drawings, in which:

FIG. 1 is a perspective view of one embodiment of an earbud according to the present technology, disposed within the ear canal of an end user;

FIG. 2A is a process flow diagram of one example of a speech recognition method according to the present technology, and application thereof;

FIG. 2B is a process flow diagram of an example of a subroutine in the method shown in FIG. 2A;

FIG. 3A is a process flow diagram of another example of a speech recognition method according to the present technology, as well as an application thereof;

FIG. 3B is a process flow diagram of an example of a subroutine of the method shown in FIG. 3A, corresponding to Step 1;

FIG. 3C is a process flow diagram of a subroutine in another example of a speech recognition method according to the present technology;

FIG. 4 is a process flow diagram of a subroutine in another example of a speech recognition method according to the present technology;

FIG. 5 is a process flow diagram of a subroutine in another example of a speech recognition method according to the present technology;

FIG. 6 is a process flow diagram of a subroutine in another example of a speech recognition method according to the present technology;

FIG. 7 is a process flow diagram of a subroutine in another example of a speech recognition method according to the present technology.

FIG. 8 is a process flow diagram of a subroutine in another example of a speech recognition method according to the present technology;

FIG. 9 is a process flow diagram of a subroutine in another example of a speech recognition method according to the present technology;

FIG. 10 is a process flow diagram of a subroutine in another example of a speech recognition method according to the present technology;

FIG. 11 is a process flow diagram of an operation of detecting whether a user is whispering according to the present technology.

FIG. 12 is a process flow diagram of a voice activity detection operation according to the present technology.

FIG. 13 is a diagram illustrating an example of a processes in the operation of FIG. 12 of comparing the energy between signals from the earbud shown in FIG. 1, according to the present technology;

FIG. 14 is a process flow of a subroutine in another example of a speech recognition method according to the present technology;

FIG. 15 is a process flow of a subroutine in another example of a speech recognition method according to the present technology;

FIG. 16 is a process flow of a subroutine in yet another example of a speech recognition method according to the present technology;

FIG. 17 is a schematic diagram of an embodiment of a system for generating voice commands according to the present technology;

FIG. 18 is a block diagram of a machine of an example of a speech recognition system according to the present technology;

FIG. 19 is a diagrammatic representation of a speech recognition system according to the present technology;

FIG. 20 is a schematic diagram of one embodiment of the voice recognition system shown in FIG. 19 according to the present technology;

FIG. 21 is a schematic diagram of another embodiment of the voice recognition system shown in FIG. 19 according to the present technology; and

FIG. 22 is a schematic diagram of another embodiment of the voice recognition system shown in FIG. 19 according to the present technology.

### DETAILED DESCRIPTION

Embodiments of the present technology and examples thereof will now be described more fully in detail hereinafter with reference to the accompanying drawings. In the drawings, elements may be shown schematically for ease of understanding. Also, like numerals and reference characters are used to designate like elements throughout the drawings.

Certain examples may be described and illustrated in terms of blocks which carry out a described function or functions. These blocks, which may be referred to herein as modules or the like, are physically implemented by analog and/or digital circuits such as logic gates, integrated circuits, microprocessors, microcontrollers, memory circuits, passive electronic components, active electronic components, optical components, hardwired circuits and the like, and may be driven by firmware and/or software of non-transitory computer readable media (CRM). In the present disclosure, the term non-transitory computer readable medium (CRM) refers to any medium that stores data in a machine-readable format for short periods or in the presence of power such as a memory device or Random Access Memory (RAM). The circuits may, for example, be embodied in one or more semiconductor chips, or on substrate supports such as printed circuit boards and the like. The circuits constituting a block may be implemented by dedicated hardware or by a specialized computer (e.g., one or more programmed microprocessors and associated circuitry, a CPU and/or a GPU, and associated memory programmed with and/or storing algorithms, operating instructions, audio signals/information, text, etc.), or by a combination of dedicated hardware to perform some functions of the block and a specialized computer to perform other functions of the block. Each block of the examples may be physically separated into two or more interacting and discrete blocks and conversely, the blocks of the examples may be physically combined into more complex blocks while still providing the essential functions of the present technology.

In addition, the terminology used herein for the purpose of describing embodiments of the present technology is to be taken in context. For example, the term “comprises” or “comprising” when used in this disclosure indicates the presence of stated features in a system or steps in a process but does not preclude the presence of additional features or steps. The term “sound” will be used in a broad sense to mean vibrations which can travel through air or another medium and which can be heard naturally or when amplified. Whispered speech or whispered voice refers to speech spoken entirely without vibration of the vocal folds and thereby having a different characteristic spectrum as compared to voiced speech. Whispered speech is typically low signal-to-noise, spoken quietly enough that an observer in a quiet environment (noise level not exceeding about 20 dB) and only a few feet from the speaker is unable to hear and discern it, and occurs similarly at a level of approximately 20-30 dB, i.e., greater than the level of sound of normal breathing and substantially less than the level of sound of normal conversation which is about 60 dB. The term “voiced speech” may thus be understood as referring to speech spoken aloud at substantially the level of normal conversation (i.e., at a level of approximately 60 dB), with many phonemes generated by vibration of the speaker's vocal folds (e.g. /b/, /z/ in English). The term “low signal-to-noise ratio” or “low SNR” is a term of art well understood by persons in the field of voice technology. The term “low signal-to-noise ratio” in the context of the present technology can pertain to whispered speech and voiced speech depending on the environment and will be understood as encompassing speech that an observer only a few feet away from the speaker cannot discern through hearing. For instance, it is understood by persons in the art that voiced speech below 20 dB SNR will not allow for good understanding in a noisy environment, whereas voiced speech below 10 dB SNR will not allow for good understanding in a quiet environment. The term “voice command” will be understood as any type of practically usable command generated from a user's speech, i.e., a text or audio command. The term “recording” may also be understood as referring to the storing of certain data (signals) in a computer's memory. The term “signal” or “signals” may also each be understood as referring to a stream of signals from one or more sensors and the like. The term “frequency domain” will be understood as a representation of a signal in terms of its constituent frequencies and/or phases. Signals may be transformed into a frequency-domain representation while also preserving temporal information by use of a windowed transform technique such as a short-time Fourier transform. Furthermore, although reference may be made to methods and systems of speech recognition, it will be understood that such methods and systems may also apply to voice recognition in which the systems and methods recognize a specific user's voice.

Note, also, for brevity and ease of understanding, the present technology will be described mainly with respect to the recognition of whispered speech but as the present disclosure makes clear, the present technology can be applied to other low SNR speech recognition. Furthermore, an earbud will be described as a wearable device having multiple sensors according to the present technology, but the present technology may be implemented using other wearable devices. Still further, methods according to the present technology may also be implemented by devices other than wearable devices but having multiple sensors arranged to produce respective channels of streams of audio signals while a person is speaking.

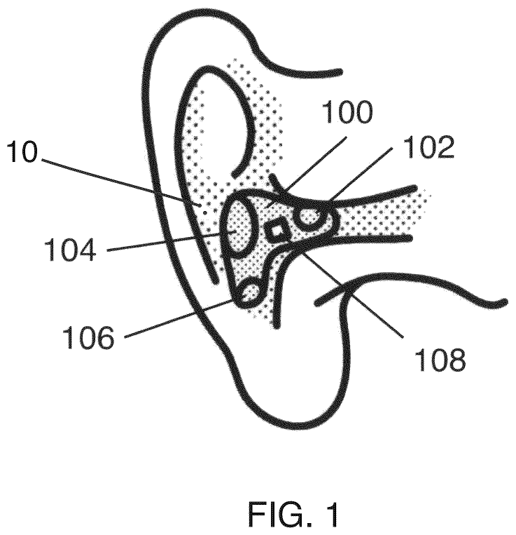

Referring now to FIG. 1, one example of an earbud 10 according to the present technology includes an earbud casing (100), inner ear microphone (102), outer ear microphone (104), mouth pointing microphone (106), and inertial measurement unit (IMU) (108). The inertial measurement unit (IMU) may be omitted in other examples of the earbud according to the present technology. As shown in the figure, at least part of the outer casing (100) has an outer contour complimentary to that of an inner contour of the human ear canal such that the ear canal is occluded when the ear bud 10 is inserted by the user into his or her ear and is thus worn by the user. In the operative occluded position of the ear bud 10, the inner ear microphone (102) is disposed in the ear canal and may be used to sense/record primarily bone-conducted speech with some small amount of background noise (suppressed due to the microphone's isolation from the end-user's environment). The outer ear microphone (104) faces outwardly as exposed to the user's environment, and the mouth pointing microphone (106) as the name implies is oriented to face substantially toward the end user's mouth to mostly sense/record speech. Either of the outer ear microphone (104) or the mouth pointing microphone may be referred to as an environmental microphone since they capture sounds conducted through the air of the environment in which the user is situated. Software used for processing output from both the outer ear microphone (104) and the mouth pointing microphone (106) is designed to produce an output that emphasizes the background noise of the user's environment. The IMU (108) is a sensor operative to detect vocal cord vibrations which are conducted through the end user's tissue. All of these sensor streams may be fused into a multi-channel audio signal for processing. The earbud 10 also includes a processing unit configured to execute denoising and voice activity detection (VAD) as described in detail herein, and a battery for powering components thereof. In some embodiments, the earbud 10 also has a conventional earbud speaker for playing music and the like through a wireless connection to a source of the music. Accordingly, the earbud 10 has a wireless interface for transmitting or transmitting and receiving audio signals.

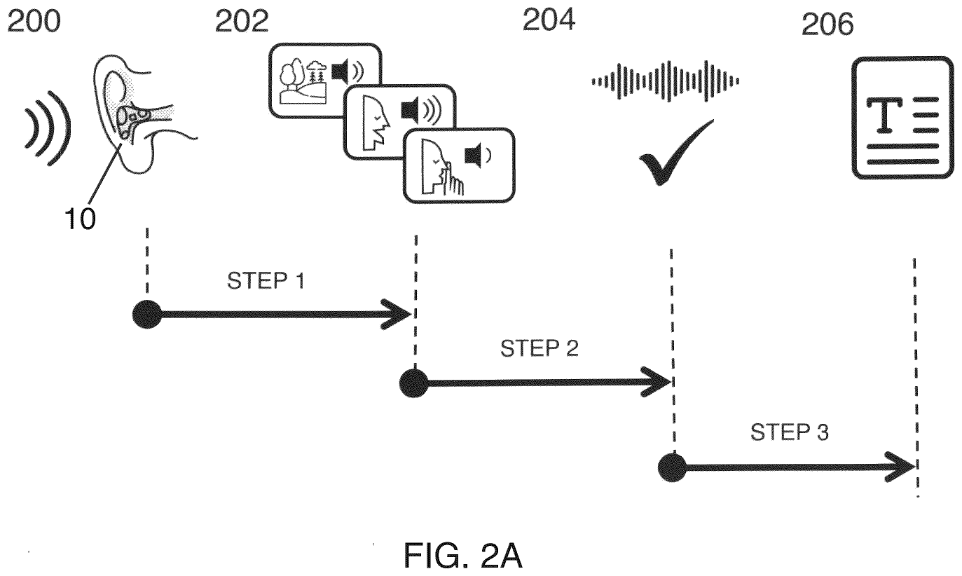

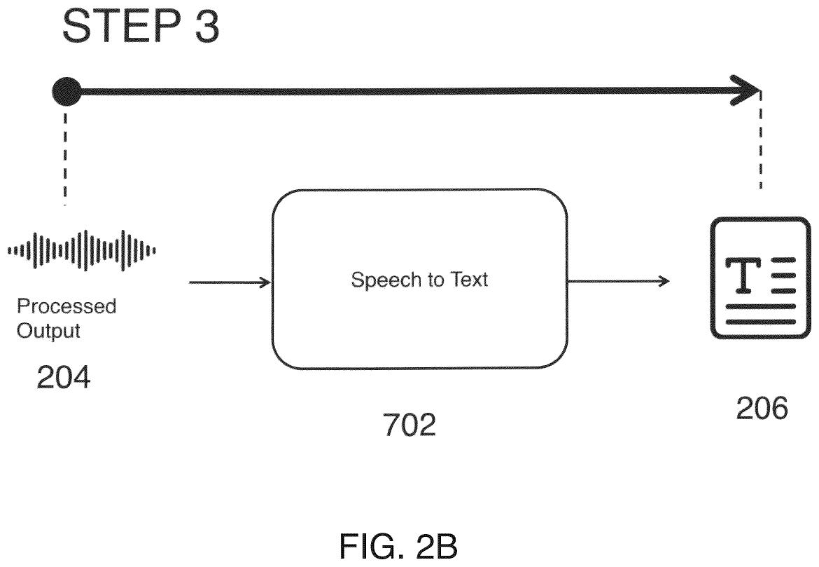

Referring now to FIG. 2A, a high-level method of detecting and processing whispered speech according to the present technology may utilize the earbud 10 of FIG. 1. In Step 1 an audio signal (200), namely, raw audio input, is collected by earbud 10 and optionally, a preliminary audio output is generated. The preliminary output (202) represents one or more detected voice activities (one or more VAD outputs) which can be grouped in various categories, and in this example the categories of the voice activities detected include background noise, voiced speech, and whispered speech. In Step 2, a denoised and compressed whispered speech signal (204) is generated. In one example, the raw audio input is denoised and compressed with activity-specific processing such that the resulting signal is a compressed signal of essentially only the whispered speech found in the preliminary output. In the descriptions that follow, a denoised speech signal created as the result of processing, such as denoised and compressed whispered speech signal (204), may be referred to as a processed speech signal or data (204).

Steps 1 and 2 may constitute a method of discerning and reproducing speech method according to the present technology, which may be referred to hereinafter simply as a speech or voice recognition method. Step 3 shows one example of an application of the method. In Step 3, the processed speech signal (204) is further processed using speech recognition software to produce a text output (206), namely an output of the text of the whispered speech in digital or displayed written form. Therefore, Steps 1-3 show what may be collectively referred to as an applied method of voice recognition.

Referring to FIG. 2B, an example of Step 3 begins with speech signal (204). The processed speech signal (204) is transmitted to a data processing pipeline (702) in a module having a speech-to-text algorithm to generate an intended output, e.g., text output (206). Although one such processed speech signal (204) is shown, the subroutine illustrated by FIG. 2B could be applied across multiple ones of such processed speech signals.

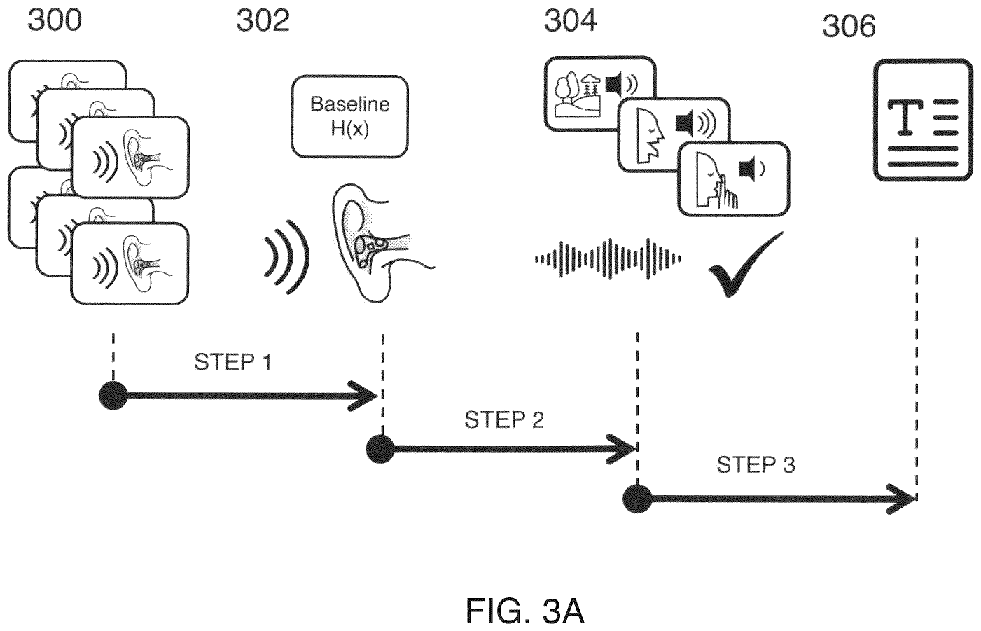

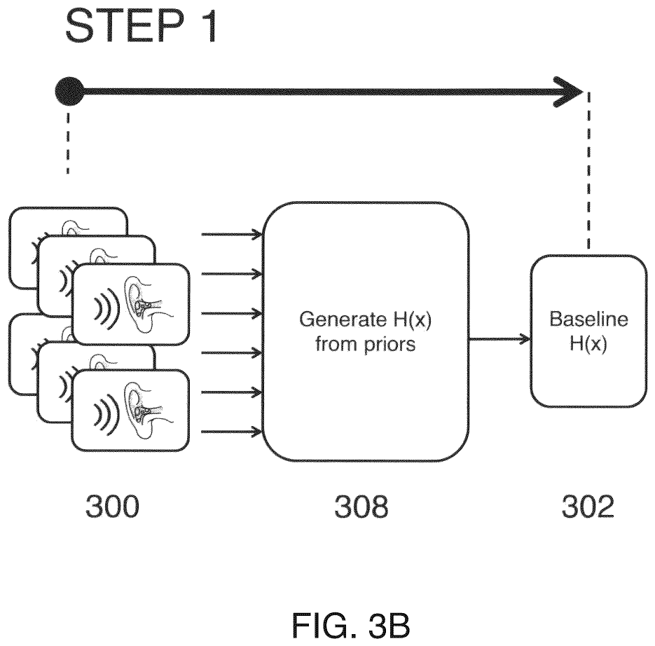

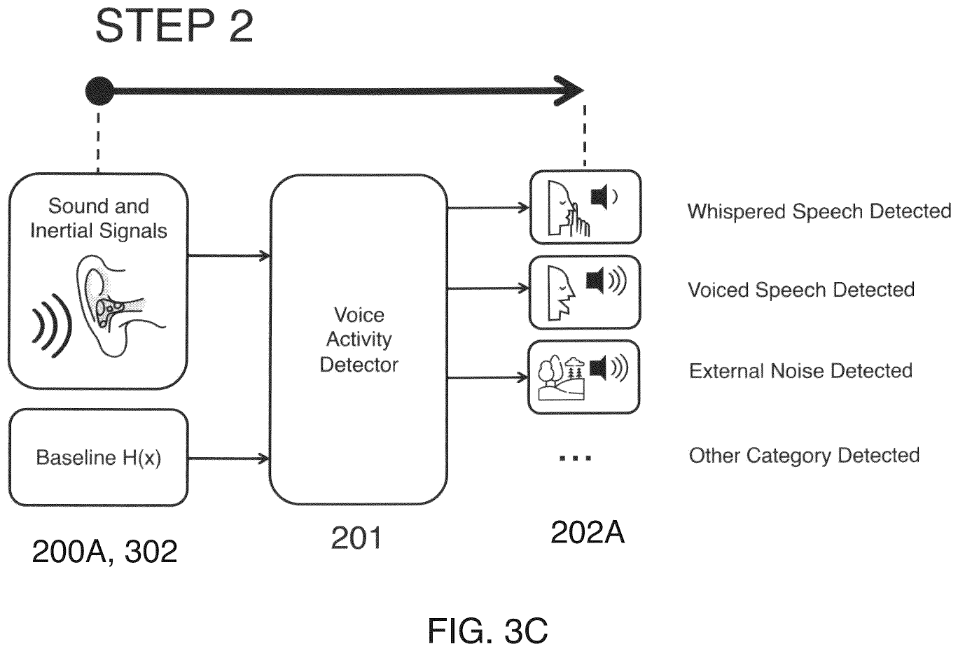

FIG. 3A shows another example of a high-level method of detecting and processing whispered speech according to the present technology, and which may also utilize the earbud 10 of FIG. 1. In Step 1, a baseline (302) based on prior audio signal training (300) and shown in the figure as Baseline H(x), for reference, is established. In addition, an audio signal is collected by earbud 10. In Step 2, an intermediate output (304) based on the baseline H(x) and the audio signal is generated. The intermediate output (304) can be, for example, a classification of voice activity contained within the signals, a denoised and compressed whispered speech signal, or both. To generate the intermediate output (304), the audio signal may be denoised (to filter out the non-whispered speech as in the prior example) using the Baseline H(x) and compressed to generate a denoised and compressed audio signal. The audio signal may also be fed into a voice activity detector to identify if whispered speech was detected. In Step 3, the resulting intermediate output (304) is processed using speech recognition software to generate an output (306), e.g., a text output as shown in the figure.

Referring to FIG. 3B, an example of Step 1, i.e., a sub-routine of the method shown in FIG. 3A, comprises deriving the baseline H(x) (302) from one or more sets of previously recorded audio data (300) according to a baseline generation algorithm (308).

Referring to FIG. 3C, in this example of Step 2, i.e., a sub-routine of another voice recognition method according to the present technology, audio signal (200A) is made up of a series of sound and inertial signals output by the earbud 10. The sound and inertial signals are input to a voice activity detector (VAD) (201) in conjunction with (predetermined) baseline H(x) (302). The audio signal (200A) is processed using the baseline H(x) (302) in voice activity detector (201) to generate a voice activity detector output (202A). The categories of sounds found in the output (202A) are differentiated from one another, and a probability weighting assigned to each category of sound is generated as the intermediate output (304 in FIG. 3A).

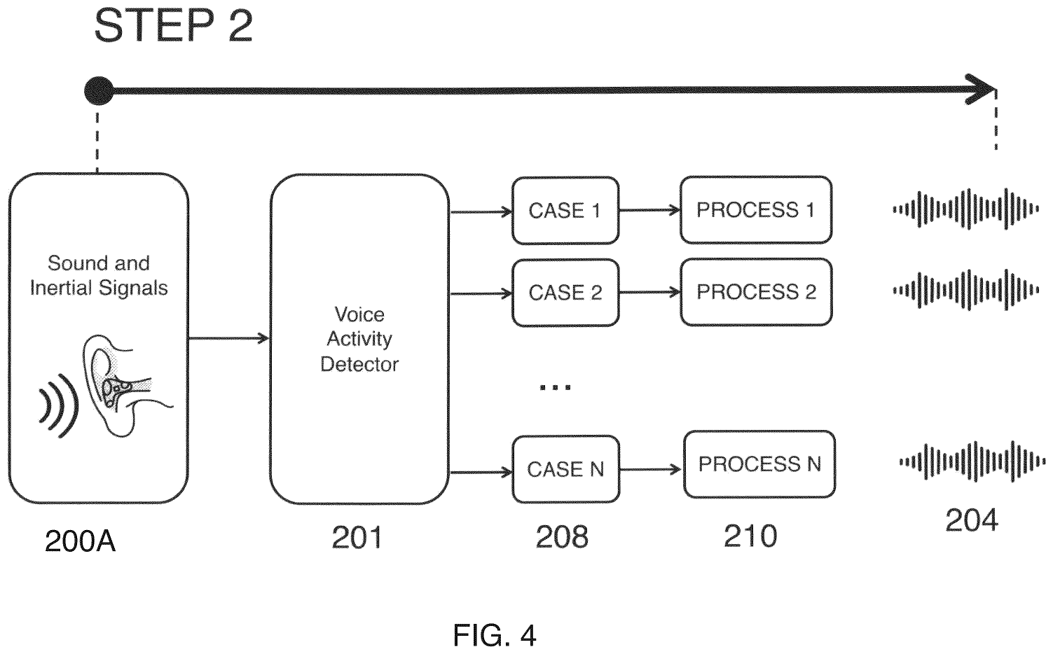

Referring to FIG. 4, another example of a voice recognition method according to the present technology comprises inputting an audio signal (200A) of sound and inertial signals to a voice activity detector (201), and selecting a processing pipeline (208, 210) which should be used to generate denoised speech signals (204).

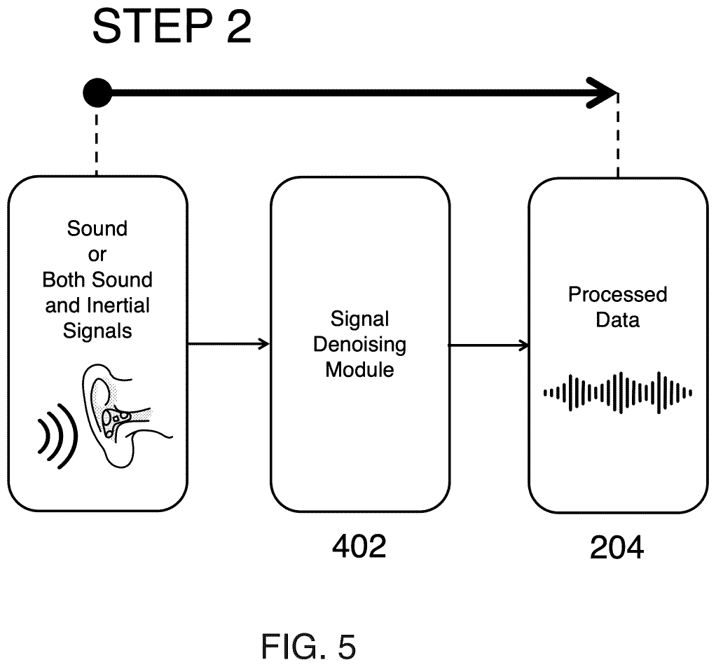

Referring to FIG. 5, another example of a voice recognition method according to the present technology comprises inputting an audio signal of sound or both sound and inertial signals directly to the signal denoising module (402) without making an explicit earlier determination (e.g., of a voice activity state) to generate processed and denoised signals (204).

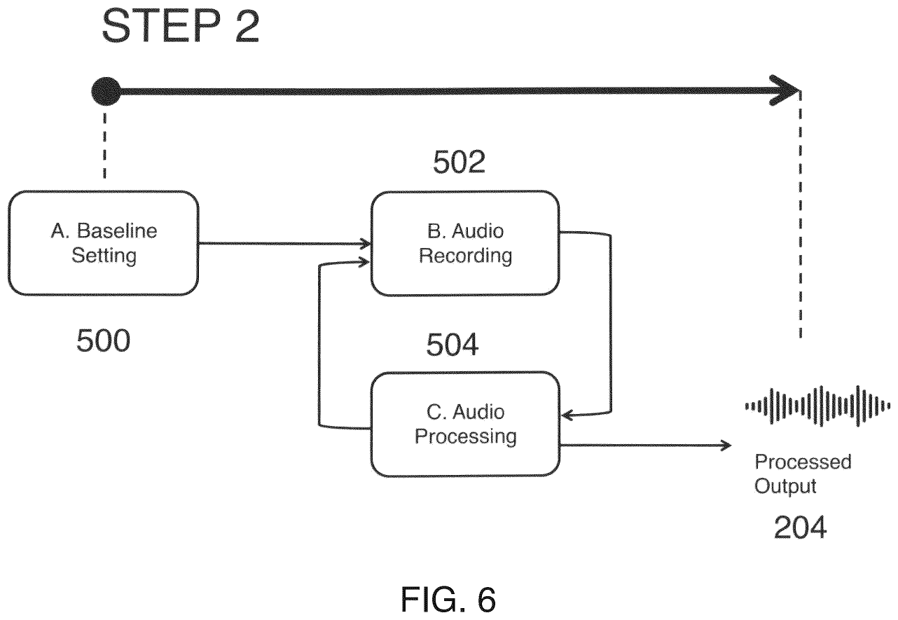

Referring to FIG. 6, another example of a voice recognition method according to the present technology comprises establishing a baseline (500), using the baseline as a threshold in recording audio data (502), and using a process (504) to process the recorded audio data to generate processed speech signal (204).

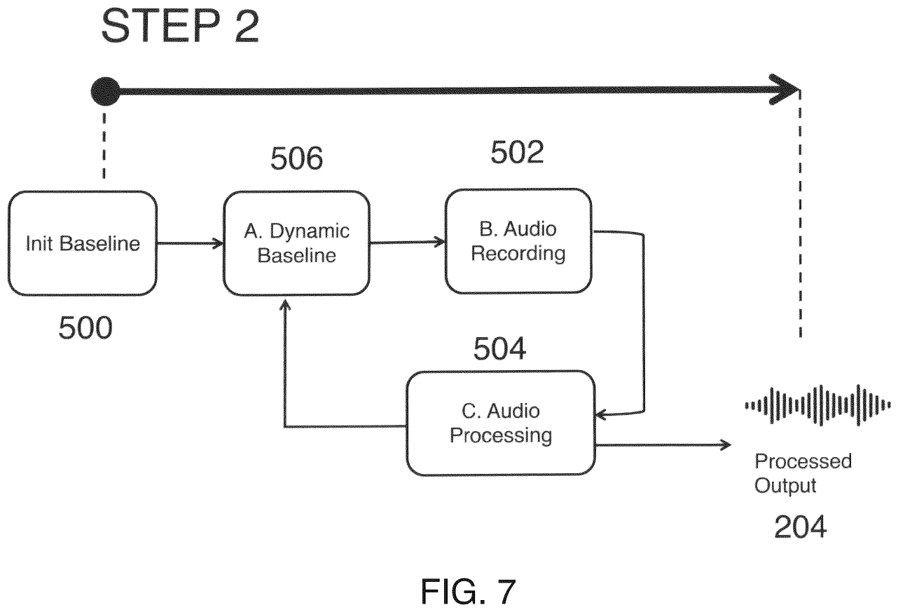

Referring to FIG. 7, another example of a voice recognition method according to the present technology comprises establishing an initial baseline (500) which is set as the initial value for the dynamic microphone baseline (506) and then recording audio data (502) using the dynamic microphone baseline (506) as a threshold. This audio data and the baseline are processed in an iterative process (504) which updates the dynamic microphone baseline (506) and generates processed speech signal (204) based on the audio data (502) and the dynamic microphone baseline (506).

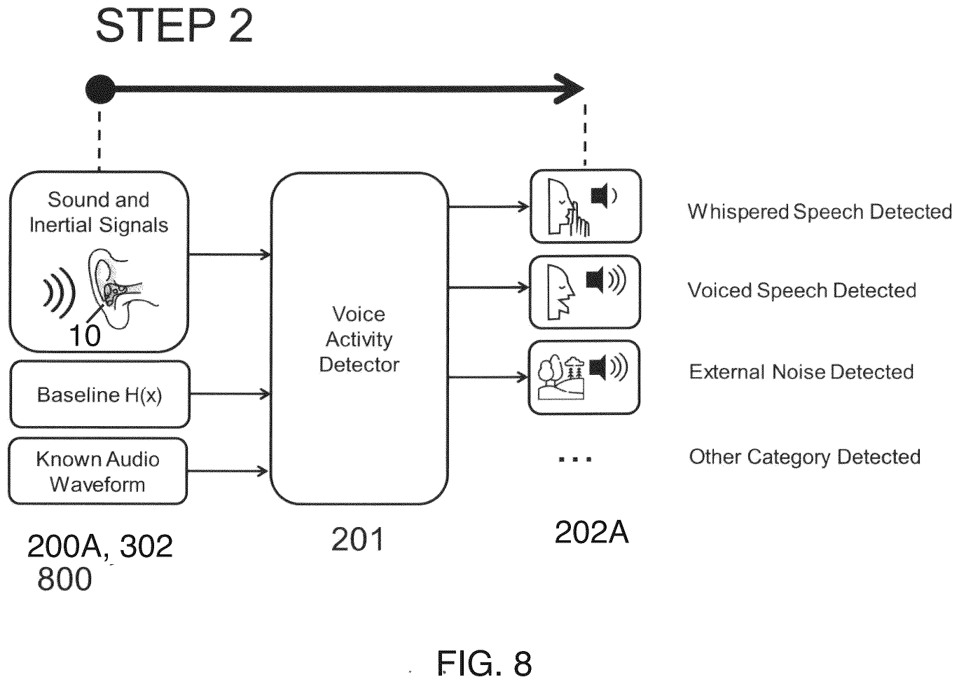

Referring to FIG. 8, in this example of step 2, a series of sound and inertial signals constituting audio signal (200A), a predetermined baseline H(x) (302), and a known audio waveform (800) are input to voice activity detector (VAD) (201) to generate a voice activity detector output (202A). In a specific implementation of this example, the baseline H(x) includes a transfer function for sounds generated outside the user's body, a transfer function for sounds generated within the user's body, and a transfer function for sounds generated by a speaker on the earbud 10. The known audio waveform corresponds to the waveform being played through the speaker of the earbud (10), such as music or a noise-cancelling waveform. The voice activity detector (201) generates an output based on the audio signal (200A), the known audio waveform (800), and the baseline H(x) (302).

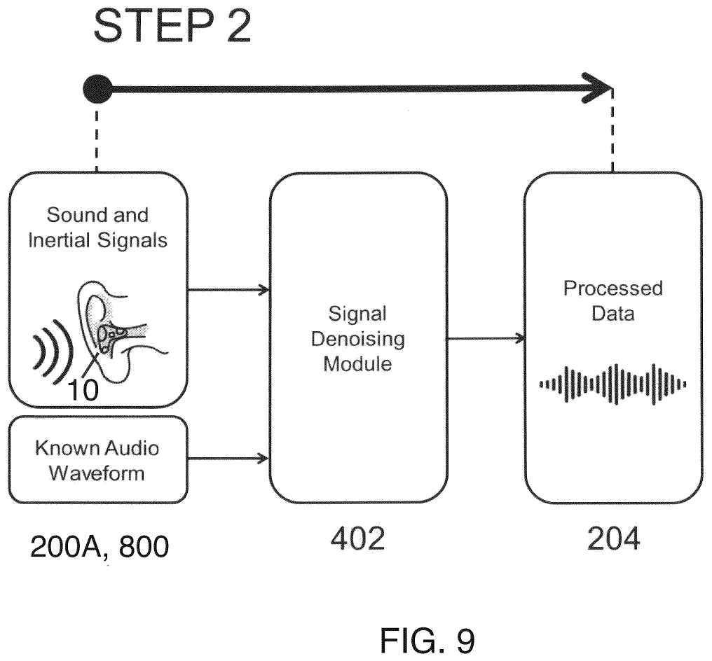

Referring to FIG. 9, in this example of step 2 a series of sound and inertial signals constituting audio signal (200A) and a known audio waveform (800) are input to a signal denoising module (402) to generate a processed speech signal (204). In a specific implementation of this example, the known audio waveform (800) corresponds to the waveform being played through the speaker of the earbud 10, such as music or a noise-cancelling waveform. The signal denoising module (402) generates an output based on the audio signal (200A) and the known audio waveform (800) that amplifies a whispered speech component and suppresses background noise and audio generated by a speaker in the earbud 10.

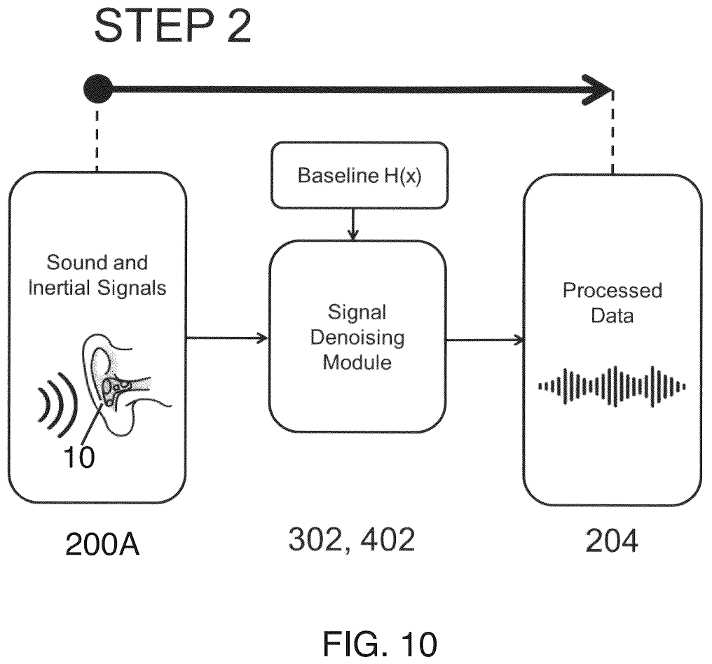

Referring to FIG. 10, another example of a voice recognition method according to the present technology comprises inputting an audio signal (200A) of sound and inertial signals and baseline H(x) (302) directly to the signal denoising module (402) without making an explicit earlier determination (e.g., of a voice activity state) to generate processed speech signal (204) based on at least the sound and inertial signals and the baseline.

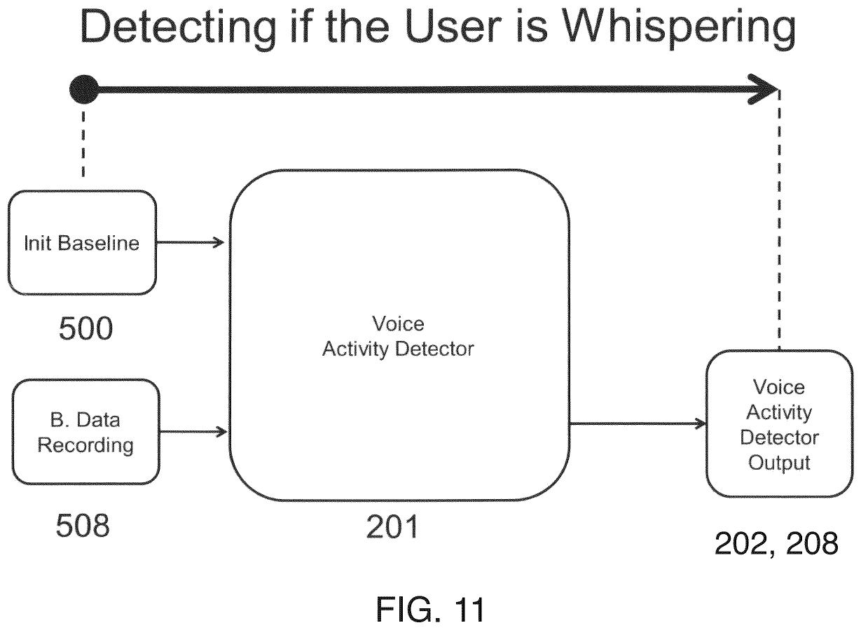

Referring to FIG. 11, an operation of detecting whether a user is whispering comprises inputting an initial baseline (500) and recorded data (508) into a voice activity detector (201) to generate a voice activity detector output (202A, 208) which may comprise a probability score or a determination of whether a user is whispering.

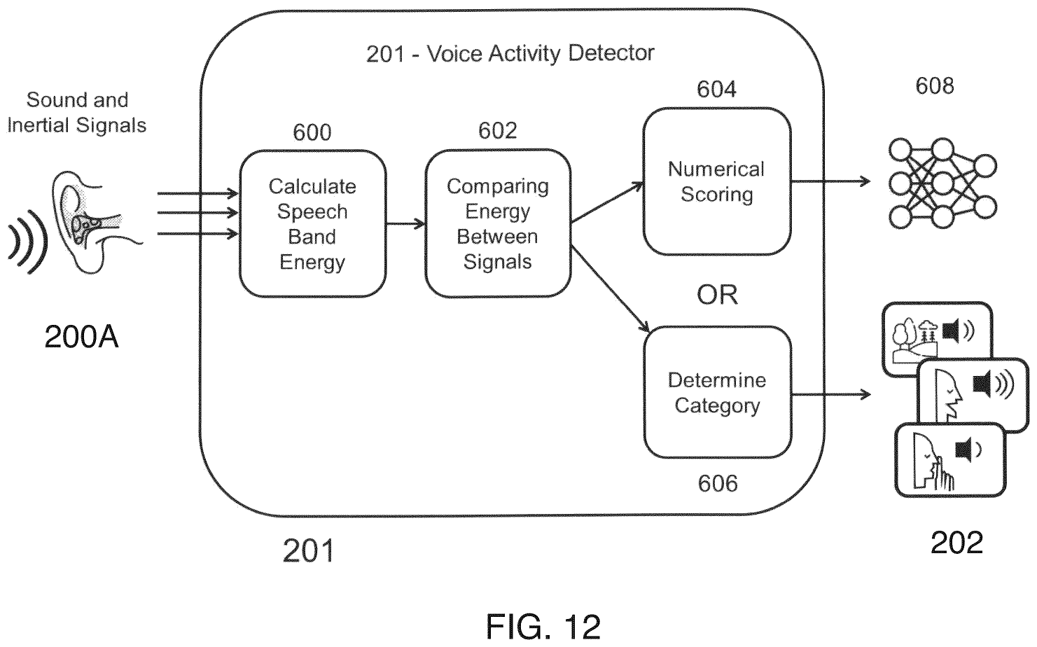

Referring to FIG. 12, a voice activity detection operation comprises receiving sound and inertial signals (200A) and inputting them into a voice activity detector (201). The voice activity detector (VAD) (201) calculates speech band energy (600) for one or more of the sound and inertial signals (200A) and compares the energy between signals (602) in the speech band or other frequency bands. The VAD (201) then generates a numerical score representing the activity state (604) or a categorical determination of the voice activity (606). In the case in which the VAD (201) generates a numerical (604), the scoring is used to generate a continuously scored activity output (e.g., a probability distribution) (608). In the case in which the VAD (201) makes a categorical determination of the voice activity (606), the categorical determination is used to generate a voice activity output (202A).

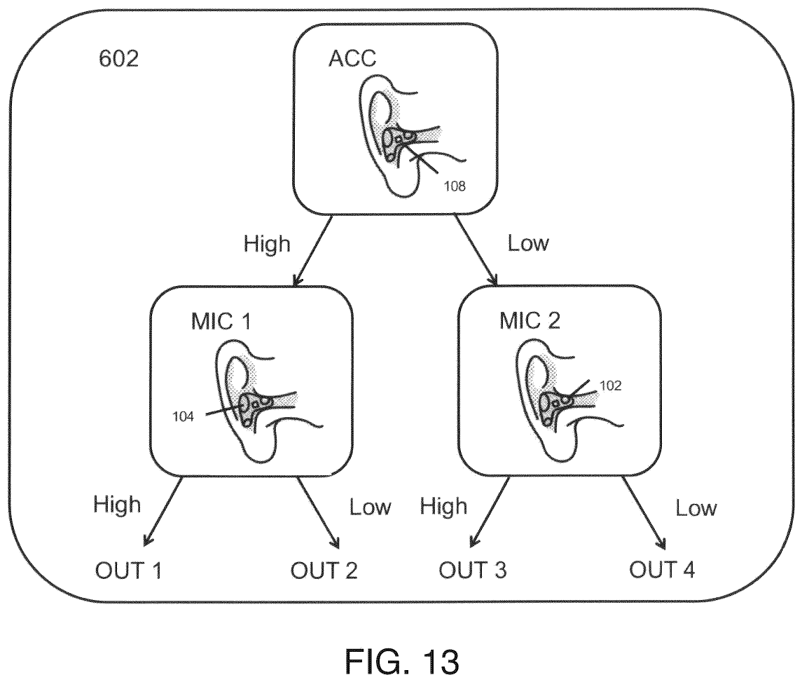

Referring to FIGS. 1, 12 and FIG. 13, in an example of operation (602) the amplitude between signals from the sensors of the earbud 10 are compared utilizing a decision tree to generate different outputs (OUT 1, OUT 2, OUT 3 or OUT 4) based on the amplitude received from each sensor. For example, a high intensity signal from the inertial sensor (108) and a low intensity signal from the environmental microphone (104) may result in a particular output (OUT 1). As another example, a high intensity signal from the inertial sensor (108) and a low intensity signal from an in-ear microphone (102) may result in yet another output (not depicted).

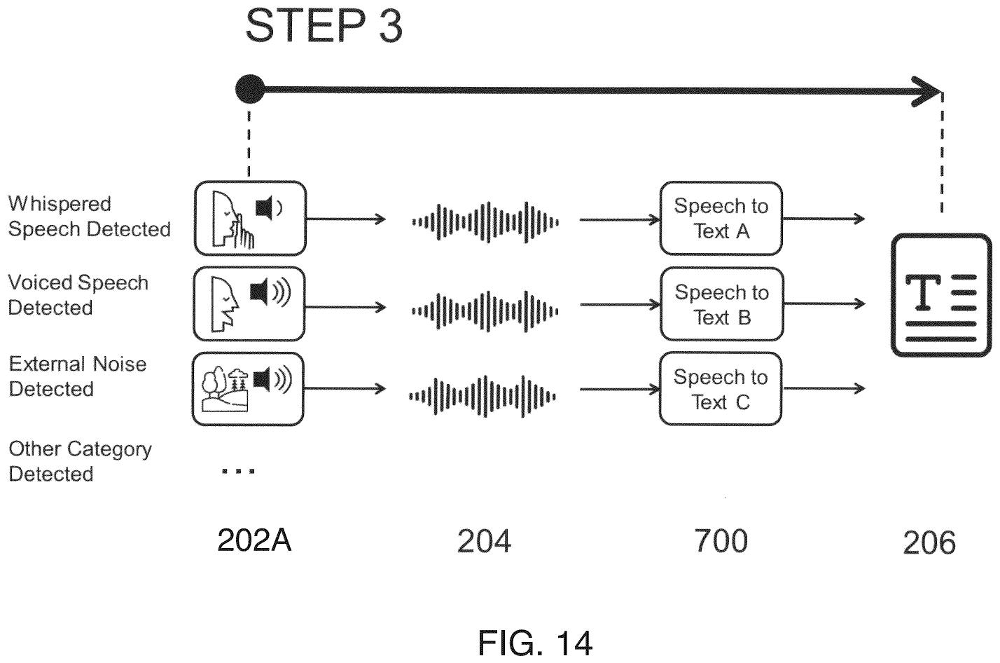

Referring to FIG. 14, in this example of Step 3, the voice activity detector output (202A) and corresponding (categorized) processed speech signals (204) are transmitted through respective data processing pipelines (700) to extract an intended output. In some examples, the data processing pipelines (700) are constituted by speech-to-text neural network models and the output is a text output (206). In other examples, the data processing pipelines receive audio and output audio rather than text. For example, the data processing pipeline may comprise a statistical model trained to receive the user's bone-conducted whispered speech and transform it into a voiced representation of the user's speech in the user's own voice. This model may operate by first transforming the bone-conducted whispered speech into text. Then, a personalized text-to-speech converter such as MaryTTS (https://github.com/marytts/marytts) is used to transform the text into speech in the user's own voice. Alternatively, the model may transform the bone-conducted whispered speech into a latent representation of the phonemes, then directly transform the latent representation into a non-bone-conducted, voiced version of the same phonemes in the user's voice, which contains more expressivity and intonation. This may be accomplished by using a neural network with an encoder-decoder structure, with training data consisting of phonemes collected from the user in both voiced and whispered speech.

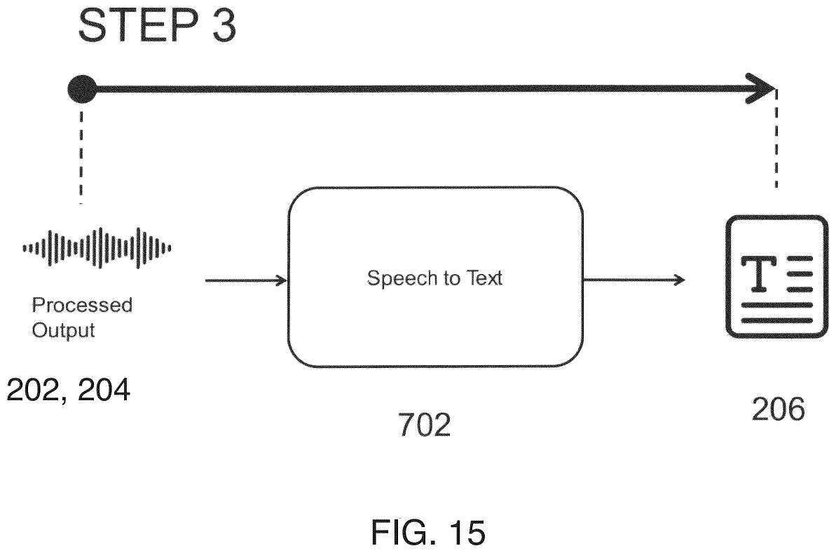

Referring to FIG. 15, in this example of Step 3, the output (202) of the voice activity/activities detected, namely the VAD output, and a processed (denoised) signal (204) are transmitted into a data processing pipeline (702) to generate an intended output. In the illustrated example, the data pipeline (702) is constituted by a module configured with a speech-to-text algorithm, and the intended output is a text output (206). In another form of this example, more than one processed signal derived from the sounds may be transmitted into the processing pipeline to generate the intended output.

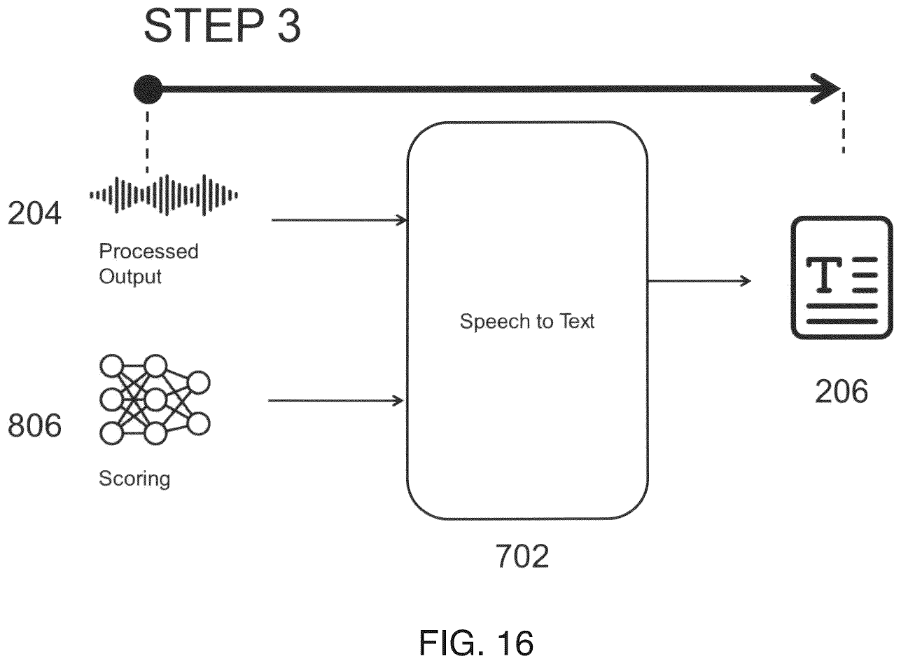

Referring to FIG. 16, in this example of Step 3, a processed speech signal (204) and a scoring representative of the activity which the signal captures (806), are transmitted into a data processing pipeline (702) to generate an intended output (206). In the illustrated example, the data pipeline (702) is constituted by a module configured with a speech-to-text algorithm, and the intended output is a text output (206). In another form of this example, more than one speech signal derived from the sounds may be transmitted into the processing pipeline to generate the intended output.

Some specific embodiments of speech recognition methods according to the present technology, based on the techniques and respective ones of the subroutines described above, will now be described in detail.

### First Embodiment

One embodiment of a whispered speech recognition method according to the present technology includes: a first step of establishing a baseline indicative of a level of isolation, and a subsequent step of detecting voice activity based on at least the baseline and acquired sound signals.

First, an expected ratio of sound between an in-ear and environmental microphone from an externally generated sound (e.g., a baseline or transfer function) is established. Then, upon receiving sound, the expected ratio is compared with the received ratio to identify which frequency bands contain sounds originating from within the user's body (e.g., speech) vs. outside the user's body (e.g., background noise). Voice activity based on the exact frequency bands and the relative intensity of sound within those bands is then detected.

### 1. Establishing a Baseline Level

During a period in which a user is not generating sound, a voice recognition method according to the present technology may establish a baseline transfer function between the in-ear and external microphone signals. Refer to FIG. 1 and the description thereof of an earbud 10 having microphones which produce such signals. In some examples, the baseline is a transfer function describing a level of attenuation as a function of frequency (in-ear signal (f) divided by external signal (f)) and/or a phase shift as a function of frequency. In other examples, the baseline is computed as the ratio of the energy of the in-ear signal and the external signal as a function of frequency for an externally generated sound not within the user's body. In yet other examples, the baseline is computed as the ratio of the energy of the in-ear signal and the external signal as a function of frequency for an internally generated sound within the user's body, such as a user's speech. In still other examples, the baseline is computed as a ratio of mel-frequency cepstrums between the one or more in-ear microphone signals and one or more external microphone signals.

In other examples, a baseline transfer function is established for externally generated sounds not originating from within a user's body.

The baseline transfer function may be established for sounds which are generated by a user and originate within the user's body, for example, voiced or whispered speech sounds, or internal sounds generated by the user's jaw, etc.

Establishing the baseline may comprise recording acoustic signals from the in-ear and external microphones, processing the acoustic signals to derive a frequency-domain representation of the signals, and computing a ratio of the energy of the two signals to determine a transfer function which serves as the baseline.

In other examples, a particular frequency band of the signal is processed after detecting the dominant frequency content of the signal to extract a higher-accuracy value of the transfer function in that frequency range, and updating the baseline transfer function in that frequency range is updated accordingly.

In some examples, a baseline is constructed by interpolating between multiple discrete frequencies or frequency bands at which a baseline value was computed.

Still further, in some examples, the baseline is established based on at least a user's characteristics, such as ear shape; and/or an earbud's characteristics, such as tip material, tip geometry; and/or a sensor's characteristics, such as microphone sensitivity, amplification factor, etc.; and/or an environment's characteristics, such as ambient soundscape, presence or absence of other users' speech, etc.

In some examples, the baseline is established over a period of time by periodically updating the baseline as new data containing high energy in a particular frequency band are acquired.

In some examples, the baseline is established during a calibration phase, in which known sounds are played into the environment or generated by a user and are received by at least the in-ear microphone and the out-of-ear microphone.

In some examples, an estimate of how well a device (the earbud, for example) is fitted to a user's body (the user's ear canal) is made based on the established baseline. The fit metric can be established based on the transfer function between the in-ear microphone and the out-of-ear microphone in a particular frequency band (e.g., 100-200 Hz, 200-500 Hz, 500-2 kHz, 2 kHz-10 kHz). A transfer function of unity indicates that the device is not fitted to the user's body at all. Also, a determination of whether a user is wearing the device may be made based on the established baseline.

In other examples, a baseline is manually set instead of being computed. For example, a baseline is manually set as the expected threshold value across a series of frequency ranges without first recording data. For example, 5 dB of isolation may be established as the baseline in a low frequency band, 15 dB may be established as the baseline in a mid-frequency band, and 10 dB may be established as the baseline in a high frequency band.

Alternatively, the baseline level of isolation is a manually established continuous function over the frequency domain relating the in-ear signal and the out-of-ear signal.

There may also be a case which establishes multiple baselines, e.g., one baseline for sounds that are generated inside the user's body and one for sounds that originate from outside the user's body, with both baselines being used for the downstream process.

### 2. Recording Data

Data (audio signals) from an in-ear microphone, out-of-ear (environmental/external) microphone, optionally a mouth (voice) microphone and optionally an inertial sensor configured to capture vibrations due to the user's vocal cords conducted through the user's head can be used to sense/record audio signals as output.

### 3. Processing Data and Generating an Output

### Comparing Against the Baseline

In some examples, the recorded signals are processed and their ratio compared to the previously established baseline ratio, and an action may be taken if the signals deviate significantly from the baseline. In some examples, the action is making a determination whether a user was speaking, and what type of speech is being spoken (whispered vs. voiced).

In some examples, two signals with a different ratio than a baseline ratio for externally generated sound indicate the presence of user-generated sound. In some examples, two signals with a different ratio than the baseline indicate the presence of unvoiced speech. In some examples, the baseline transfer function is used to transform one of the signals into a relevant domain for direct comparison with the other in a denoising process. In some examples, transforming one of the frequency-domain signals by the transfer function and subtracting from the other will result in some frequencies which have relatively large amplitudes and some which have near-zero amplitudes. In some examples, the user's speech status (uttering no speech, whispered speech, or voiced speech) is determined by identifying which frequencies have relatively larger amplitudes in the output of this signal denoising process—if the frequencies correspond to whispered speech frequencies, then it is determined the user was whispering; and if they correspond to voiced speech frequencies, then it is determined the user was making voiced speech. Different examples may use different time durations for recording of the speech signals.

In some examples, an estimate of how well a device is fitted to a user's body is made based on deviations between the signals and the previously established baseline. In some embodiments, if a “well-fitted” baseline had been previously established, a reduction in the ratio of the two signals is used to indicate a reduction of acoustic isolation and therefore lead to a determination that the device fit has been reduced.

### Filtering

One or more filters may be used to process the recorded data. These may be bandpass filters, high-pass filters, low-pass filters, and may be implemented in electronics, low-level firmware to be run on a microprocessor, or software to be run on higher-compute devices. Cutoff frequencies for the filters may be selected based on characteristics of the user's voiced and unvoiced speech such as to increase the signal-to-noise ratio of speech.

### Energy Thresholds, Cross-Correlation

Determining whether unvoiced speech is detected may also be performed by calculating the total energy in an unvoiced frequency band of the in-ear microphone signal, and the energy of the same frequency band of the out-of-ear microphone signal, and comparing the total energies to identify whether user-generated speech sounds are present. Because the in-ear microphone is normally isolated from the environment by at least 5-20 dB, and because unvoiced speech conducts more readily through the body than environmental sound, an increased ratio of the energy in an unvoiced speech frequency band in the in-ear microphone signal as compared to the energy in the same frequency band of the out-of-ear microphone signal indicates the presence of unvoiced speech.

To assist in the comparison, in addition to calculating the energy in the speech band for both microphones, the total energy in a noise band of the in-ear signal can be calculated, the total energy in a noise band of the out-of-ear signal could be calculated to verify the level of environmental isolation achieved by the in-ear microphone, and the energy ratio in the noise band vs. the energy ratio in the speech band to identify if the user was speaking is calculated. If the energy ratio of the noise band is equal to the energy ratio of the speech band after adjusting for the transfer function of the in-ear microphone, then the user was not speaking. If the energy ratio of the speech band is greater than the energy ratio in the noise band after adjusting for the transfer function and a predetermined threshold (some manual tuning) for speech detection (with the ratio defined as in-ear divided by out-of-ear), then a determination is made that the user was speaking. The transfer function mentioned earlier is an expression of a frequency-dependent function of the intensity and/or phase of sound at each frequency in the in-ear microphone as compared to the out-of-ear microphone. A transfer function is not equal to unity at speech-relevant frequencies because the in-ear microphone is acoustically coupled to the ear canal and at least partially acoustically shielded from the ambient environment.

In other examples, an in-ear microphone and an inertial sensor (e.g., an inertial measurement unit (IMU)) of the earbud are used together for detection of whispered speech and rejection of motion noise. The IMU is sensitive to bone-conducted voiced speech frequencies, but not to bone-conducted whispered speech frequencies. Therefore, if the output of the IMU has a high amplitude and the output of the in-ear microphone has a high amplitude then a determination is made that the user is uttering voiced speech. If the output of the IMU has a low amplitude and the output of the in-ear microphone has a high amplitude and the output of the external/mouth microphone(s) has/have a low amplitude, then a determination is made that the user is uttering whispered speech. If the output of the IMU has a low amplitude, the output of the in-ear microphone has a high amplitude and the external/mouth microphone(s) has/have a high amplitude, then the signals are processed using transfer functions to determine if the high amplitude of the output of the in-ear microphone was due to whispered speech or transmitted noise.

Quiet vs. loud speech can be distinguished by seeing if the speech signal is detectable in both microphones (indicating loud speech) or just the in-ear microphone (indicating quiet speech). This is dependent on the fact that the in-ear microphone is occluded in the ear canal, and the out-of-ear microphone is facing the environment of the wearer of the earbud. This also depends on the position of the out-of-ear microphone, so the definition of “detectable” can be defined based on the overall sensitivity of the out-of-ear microphone, which is dependent on its internal sound sensitivity, amplification characteristics, and position and orientation relative to the mouth of the user.

Unvoiced (whispered) vs. voiced speech can be distinguished by comparing the frequency spectrum to a known frequency spectrum of whispered or voiced speech. Voiced speech can be detected by the presence of harmonic vocal fold vibrations in a voiced frequency range.

Speech vs. sound can also be detected due to the unique frequency patterns of speech as compared to other user-generated noise, e.g., the energy vs. time of the in-ear microphone can be used to discriminate between user speech and other user-generated sounds (e.g., breathing). In some examples, the in-ear microphone is used to detect the presence of multiple plosives (e.g., t, k, p, d, g, b) that leave a unique signature which is distinct from other user generated sounds or ambient sounds. This may be detected as intermittent, short-duration pulses of high-energy in the speech signal.

Alternatively, a speech-to-text algorithm can be trained to reject other noises and used for detecting speech vs. noise.

### Second Embodiment

A second embodiment of an approach to whispered voice recognition according to the present technology entails voice activity detection with isolation of an internal (in-ear) microphone.

A method of detecting a user's voice activity, according to the present technology, includes generating by a voice activity detector (VAD) a VAD output based on (i) external acoustic signals received from at least one environmental microphone located outside an ear canal and (ii) internal acoustic signals received from at least one internal microphone located inside an ear canal, the in-ear microphone detecting acoustic signals transmitted through the tissue of the user's head. The internal microphone is at least partially acoustically isolated from the environment. The level of isolation from environmental sound of the internal microphone is greater than [5 dB, 10 dB, 15 dB, 20 dB] in a speech frequency range. Note, however, these values are representative only. The isolation is achieved by use of a compliant material coupled to the internal microphone outlet port, to be placed within a user's ear canal.

The generating of the VAD output includes detecting unvoiced speech in the acoustic signals by: analyzing at least one of the external acoustic signals and at least one of the internal acoustic signals; if an energy envelope in an unvoiced speech frequency band of the at least one of the internal acoustic signals is greater than a first threshold, and an energy envelope in an unvoiced speech frequency band of the at least one of the external acoustic signals is less than a second threshold, a VAD output for unvoiced speech (VADu) is set to indicate that unvoiced speech is detected.

In another example, the VAD output includes detecting unvoiced speech in the acoustic signals by: combining at least one of the external acoustic signals and at least one of the internal acoustic signals to create an enhanced acoustic signal; if an energy envelope in an unvoiced speech frequency band of the enhanced acoustic signal is greater than a threshold, a VAD output for unvoiced speech (VADu) is set to indicate that unvoiced speech is detected.

In another example, the VAD output can be produced by making a determination of whether the user is generating unvoiced speech, generating voiced speech, or generating no speech, by: combining at least one of the external acoustic signals and at least one of the internal acoustic signals to create an enhanced acoustic signal; determining that the user is generating speech when an energy envelope or signal intensity or information content in a speech frequency band of the enhanced acoustic signal is greater than a threshold; and, if the enhanced acoustic signal contains vocal fold vibrations, determining that the user is uttering voiced speech and, if not, determining that the user is uttering unvoiced speech.

The VAD output can be set to indicate that unvoiced speech is detected, and in this case an enhanced unvoiced speech signal is produced by blending, via a Signal Fusion Module, the at least one of the internal acoustic signals and the at least one of the external acoustic signals. The signal fusion module is configured with a trained statistical model. The trained statistical model is configured to receive a frequency-domain representation of the acoustic signals and output an enhanced frequency-domain representation of the unvoiced speech signal. The frequency-domain representation of the acoustic signals is time-aligned Mel-frequency cepstral coefficients.

The trained statistical model compresses the enhanced signal in memory by at least 2-fold as compared to the input acoustic signals. In fact, the model may compress the enhanced signal in memory as much as 5-fold or even 10-fold as compared to the input acoustical signals. The trained statistical model has at least one architectural element selected from the group consisting of: convolutional elements, recurrent elements, encoder-decoder elements, self-attention elements.

Next, examples of generating a denoised and compressed whispered voice detection signal in methods and systems according to the present technology will be described in more detail. A user's whispering can be detected by any of the voice recognition methods described herein. In some examples, the detection of a whisper triggers a recording of more data. In some examples, if a whisper is detected, the process flow is to continue recording and begin generating the denoised and compressed speech signal and inputting the signal into a trained statistical model for speech-to-text. The statistical model may be one previously trained on whispered speech data and/or denoised and compressed speech data, and/or voiced speech data.

### 1. (Optional) Trigger for Initiating a Whispered Speech Recognition Process

### Manual Trigger

A gesture from a user's body part can be used to trigger the process, e.g., a pinch from a hand, contact between one part of a user's body and another, a UI/UX gesture such as tap, swipe, scroll, etc., or a gesture involving contact between a user's body part and a surface. Alternatively, an input from an external device (e.g., computer or phone shortcut, button press, screen tap, scroll, etc.) can be used to trigger the process. For example, a physical input from the system itself (e.g., a button press, a motion signature indicating a tap event, a capacitive touch event, an audio signature indicating a user input) can be used to trigger the process.

### Keyword Trigger

A whispered keyword can be detected and used to trigger the process, by passing the denoised and compressed speech signal into a statistical model trained to recognize the keyword. The model may use various standard features of the keyword to identify it, including spectral features, baseline crossings, energy features, etc. and can be performed by clustering, similarity metrics with a threshold, etc. Alternatively, a voiced keyword can be detected using the methods described above.

### Sound-Based Trigger

A user-generated sound (e.g., bone-conducted sounds such as jaw click, face-tap) can be used to trigger the process. Alternatively, sound emanating from another device, such as a computer, can be used to trigger the process.

### 2. Ensuring the Device is in a User's Ear

Before recording data, whether the in-ear microphone is sufficiently attached to the user's ear canal can be identified by means of a proximity sensor (e.g., capacitive or optical), and/or by comparing the energies of signals in multiple bands of the in-ear microphone and the out-of-ear microphone to verify that at least (3-10 dB) of attenuation is achieved and/or by sensing the motion characteristics of the device and comparing the motion characteristics (e.g. magnitude, frequency, etc.) to known motion characteristics (e.g. thresholds, etc.) for a device that is properly placed in a user's ear.

### 3. Recording Data

### Noise and Unvoiced Speech Components of Signals

Data is recorded from at least a body-coupled microphone configured to collect speech signals conducted through the user's body tissue, and an environmentally coupled microphone configured to collect ambient noise signals. Data may also be recorded from an environmentally coupled microphone directed towards the user's mouth, configured to collect sounds emanating from the user's mouth. Data may also be recorded from an inertial sensor that is coupled to the housing of the device which may be coupled to the user's ear—the inertial sensor being configured to receive vibrations due to the user's vocal cord vibration. Data may also be recorded by a capacitive or optical sensor coupled to the user's ear.

### Frequency Response of Each Microphone (Isolation, Solves Low SNR Issue)

In some examples, the frequency response of the in-ear microphone to ambient sound is modified from the frequency response of each of the out-of-ear microphones to ambient sound by a transfer function over the frequency domain. In some examples, the frequency response of the in-ear microphone to sounds generated by the user (e.g., voiced speech, whispered speech, mouth click, nasal inhale) is modified from the frequency response of each of the out-of-ear microphones to sounds generated by the user by a transfer function over the frequency domain.

The transfer function may be measured during operation (see earlier discussion of measurement). The transfer function may be predetermined prior to data collection. The transfer function may be modified for sounds generated from different positions outside the ear. Externally generated signals are attenuated by more than 3 dB over a speech frequency band in the in-ear microphone as compared to the environmentally coupled microphone.

### Microphone Positions and Angles

The recording is carried out using the multiple sensors of the earbud 10 shown in and described with reference to FIG. 1. In some examples, the external microphone 104 is oriented in a fixed direction relative to the in-ear microphone 102. The external microphone 104 is oriented to increase the fidelity of the external background noise signal. The internal and external microphones 102, 104 are oriented such that the signals collected by each microphone are different, allowing for multimodal sensing.

The sensors may also include an inertial sensor is located within the body of the earbud. In this example, the active recording of data by the microphones and inertial sensor can be toggled on and off over the usage of the device.

### Detecting the End of a User's Input

The end of the user's input to the sensors aims to reduce response latency by ˜500 ms. To this end, in some examples, the end of a user's input is indicated by an external trigger, such as a button tap, gesture event, or direct trigger from a peripheral device. In other examples, the end of a user's input is indicated by a long pause in speech In other examples, the end of a user's input is indicated by the detection of the user taking a breath. In still other examples, the end of a user's input is indicated by a semantic end of phrase, or otherwise indicated using the context of the recorded content.

### 4. Signal Pre-Processing

In some examples, signal pre-processing includes creation of mel-spectrograms from the captured/recorded sounds (e.g., audio signal 202 or 202A). In some examples, the signal pre-processing includes applying transfer functions to the environmental microphone signals to transform them into the same domain as the in-ear microphone and allow for more simple comparisons and cross-correlation between the signals. The signal pre-processing may include time-synchronizing of the signals. The time-synchronizing may include computing a cross-correlation between two signals.

In some examples, the signal pre-processing includes noise reduction using techniques such as spectral subtraction, adaptive noise cancellation, or wavelet denoising. The signal pre-processing may include segmentation of audio signals into smaller frames. The signal pre-processing may impose frequency shifts, such as pre-emphasis to boost higher frequency components or equalization to emphasize specific frequency ranges. In some examples, the signal pre-processing includes filtering, such as bandpass, low-pass, or high-pass filters to isolate specific frequency components or remove unwanted frequencies. In some examples, the signal pre-processing includes dynamic microphone range compression. In some examples, the signal pre-processing employs a known signal (e.g., an output of a speaker that affects the in-ear microphone signal and/or the inertial signal).

### 5. Denoising in a Denoising Module

The signal alignment (time synchronization) includes spectral subtraction to estimate the noise spectrum in a non-speech section of the audio and subtract it from the spectrum of the entire signal. The denoising may include the application of adaptive filtering, such as wiener filtering, Least Mean Squares (LMS) algorithm or Recursive Least Squares (RLS) algorithm. The denoising may be provided by statistical modeling architectures to draw a complex mapping. Regarding a neural network for denoising, a pretrained encoder-decoder neural network may be used. In this example, the network receives at least the preprocessed in-ear microphone signal and the preprocessed environmental microphone signal and reconstructs a denoised microphone signal. The denoising may achieve a data compression of at least ˜50% between the multichannel sensor inputs and the denoised sensor output.

Some embodiments of speech recognition systems according to the present technology, by which the methods techniques and respective ones of the subroutines described above may be implemented, will now be described in more detail.

A system according to the present technology comprises: at least two microphones within a common housing, one to be positioned within a user's ear canal and another to be positioned facing the environment in which the user is situated, wherein one microphone is an in-ear microphone isolated from ambient noise by at least 3 dB, and preferably by at least 5 dB, such that the in-ear microphone receives acoustic signals transmitted through the user's body; and a computer system module configured to process at least the two signals and generate an output of a user's voice activity. The microphones may constitute an earbud such as earbud 10 shown in and described with reference to FIG. 1. In one example, the computer system module comprises a voice activity detector, such as VAD 201, configured to discern whether the user is speaking normally, speaking quietly, whispering, or not speaking.

The microphones, e.g., in-ear microphone 102 and environmental microphone 104, may be positioned within 4 cm of each other within a common housing. In addition, the housing, e.g., housing 100 of the earbud 10, may have internal and external microphone vent opening orientations which differ by a minimum of 90 degrees as measured from the centers of the vent openings of the microphone. More specifically, lines passing perpendicular to planes of the vent openings of the microphones, through geometric centers of the openings, subtend an angle of at least 90 degrees.

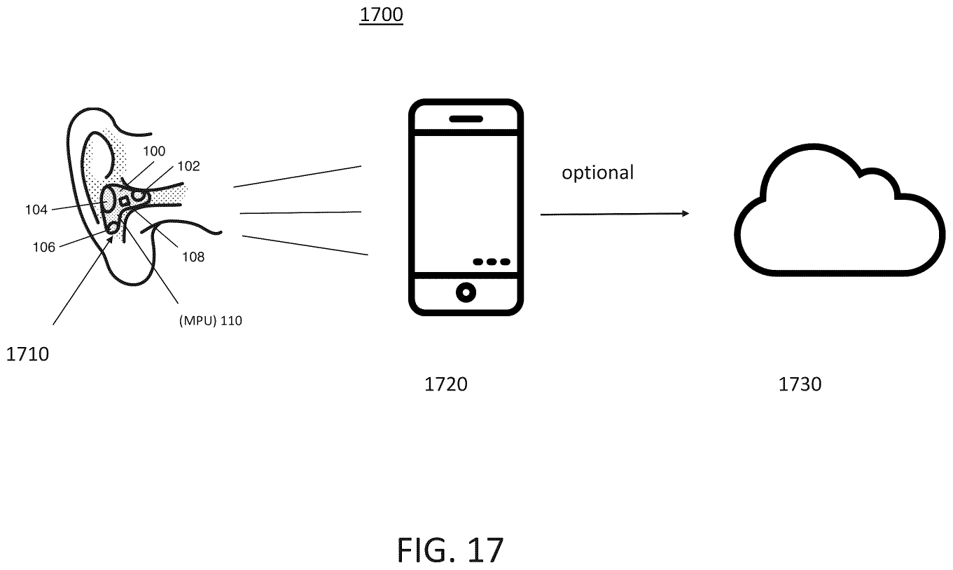

FIG. 17 shows a speech recognition system 1700 for generating voice (audio or text) commands according to the present technology. In this example, the speech recognition system 1700 includes: a wearable device such as an earbud 1710, a local device 1720, and optionally the cloud 1730. The earbud 1710 may be the same as any of those described above including that shown In FIG. 1. In the illustrated example, the earbud 1710 is also provided with an earbud microprocessor 110. The local device 1720 may be a phone or laptop or custom case for the earbud 1710, constituting a machine of a computer system. More specifically, the local device 1720 may include a device processor such as a CPU or GPU. The cloud 1730 may also constitute the “computer system”, comprising one or more servers including a cloud processor (CPU or GPU). Transmission of signals from the earbud 1710 to the local device 1720 may be made by Bluetooth or Wi-Fi equivalent. Typically, when neural networks are employed, they are realized in a GPU of the system.

In one example of this embodiment, the earbud microprocessor 110 is configured with and runs the voice activity detection and denoising/compression algorithm. The denoised/compressed signal produced as a result is transmitted over Bluetooth or the like to the local device 1720. The local device 1720 is configured with and thus runs a speech-to-text neural net to generate a text output.

In another example of this embodiment, the earbud microprocessor 110 is configured with the voice activity detection and denoising/compression algorithm, then transmits the denoised/compressed signal over Bluetooth to the local device 1720. The local device 1720 transmits the signal over a wireless cellular network such as Wi-Fi or LTE to the cloud 1730. The cloud 1730 is configured with and thus runs a speech-to-text neural net to generate a text output which is sent back to the local device 1720.

In some examples, the text output is passed into a large language model in the cloud 1730. In some examples, the large language model is configured as an AI assistant to take digital actions based on the text and prior context from the user.

The CPU or GPU is provided with modules that are configured to execute the process and operations described above. As examples, a CPU or GPU of system 1700 is provided with modules, including but not limited to voice activity detector (VAD) (201) configured with an algorithm such as Google's WebRTC VAD; baseline generation algorithm (308) as exemplified by an algorithm that computes a Fourier transform of two or more datasets and divides the frequency-dependent intensity of one by another to generate a baseline transfer function; signal denoising module (402) as exemplified by a module having a high-pass and a low-pass filter and configured with a denoising algorithm that computes a Fourier transform of a signal, filters the transformed signal with the high-pass and a low-pass filter to reject noise outside of a speech band, and a Fourier algorithm that computes the inverse transform to reconstruct a denoised signal; a module including a memory and processor configured to record data from one or more microphones for executing the recording audio data (502) process; a module configured to compute a mel-frequency spectrogram and compare the magnitudes of the spectrogram at particular frequency bands and thereby calculate speech band energy (600) for one or more of the sound and inertial signals and compare the energy between signals (602) in the speech band or other frequency bands; and a processor and GPU configured as a trained transformer-based statistical model speech-to-text neural network to execute a speech-to-text conversion.

One example of method implemented by system 1700 comprises: first establishing a frequency-dependent transfer function from an out-of-ear microphone of earbud 1710 to the domain of an in-ear microphone that is at least partially acoustically isolated from the ambient environment (this can be established, for example, by measurement of a calibration signal on both microphones); subsequently recording signals from the in-ear microphone and the out-of-ear microphone in a time-synchronized manner, subsequently passing the recorded signal into voice activity detector (VAD) (201) that detects if the user was whispering based on the energy in a speech band of the signals. (For example, a high level of energy in the speech band of the output of the in-ear microphone indicates voiced speech, a medium level of energy in the speech band of the output of the in-ear microphone simultaneous with a low level of energy in the speech band of the output of the external microphone indicates whispered speech, and a medium level of energy in the speech band of the output of the in-ear microphone simultaneous with a high level of energy in the speech band of the output of the external microphone indicates ambient noise in the speech band). Then if a determination was made that the user was whispering, the method progresses by passing the signals and transfer function to the denoising and compression module. In the denoising and compression module, the out-of-ear signal is first transformed by the transfer function to the domain of the in-ear signal. This transformed signal is then subtracted from the in-ear signal to create a denoised and compressed speech signal which represents the in-ear signal with the background noise removed while preserving the tissue-conducted whispered speech signal. Subsequently, the denoised and compressed speech signal is input to an output generation module to generate an output. (For example, the module may be a pretrained convolution-based trained statistical model that takes in tissue-conducted whispered speech and generates a text output of the words which were whispered).

Another method employing the denoising and compression module comprises using a pretrained encoder statistical model or neural net that receives two or more input signals, one of which is from an in-ear microphone, and outputs a single denoised and compressed signal. For example, pretrained encoder statistical model or neural net might receive two time-synchronized signals, one from an in-ear microphone and one from an ambient microphone. In some embodiments, the statistical model is implemented as a fully convolutional encoder-decoder network as described by Long et al., 2015 (J. Long, E. Shelhamer and T. Darrell, “Fully convolutional networks for semantic segmentation,” 2015 IEEE Conference on Computer Vision and Pattern Recognition (CVPR), Boston, MA, USA, 2015, pp. 3431-3440) using common libraries such as Tensorflow or Pytorch. Other embodiments use transformer-based diffusion neural networks or U-net neural networks, also implemented using well-documented libraries in Tensorflow or Pytorch. In one specific embodiment, the time-synchronized timeseries signals are converted to a Mel-spectrogram before they are passed as inputs to the statistical model. In one specific example, a 1-second-long signal from two microphones is formatted as a 2 by 512 by 512 Mel-spectrogram image, and used as the input for a statistical model as described by Ronneberger et al., 2015 (arxiv.org/abs/1505.04597), configured to output a denoised and compressed 1 by 512 Mel-spectrogram image in an encoder-decoder architecture. The pretraining process is designed to result in a trained statistical model that rejects background noise and amplifies speech signal. For example, the model is trained on data which is a combination of a recorded noise signal and a recorded clean whispered signal in a quiet environment, with an objective function based on reconstructing the clean whispered signal from the multiple channels with artificially-added noise. The training may be implemented by a GPU running code based on common machine learning frameworks such as Tensorflow and Pytorch. It can be understood that common machine learning modules such as regularization units, batchnorm, rectified linear unit activation functions, cross-entropy loss, etc. will be used in this implementation to train the statistical model, as described by the well-documented Tensorflow and Pytorch libraries in Python. Training may be additionally conducted by concatenating the denoising model with a pretrained speech-to-text model and training both models together to reconstruct the final text output based on the speech signal with added noise, therefore allowing the denoising model to construct an output which further emphasizes features that are of high value to the speech reconstruction process. The additional training may be implemented by similarly using well-documented Python libraries to connect a larger pretrained speech-to-text model to the output of the denoising and compression statistical model, then allowing for backpropagation through the larger speech-to-text model to the denoising and compression model to create a more optimized denoising model for text output via the speech-to-text model.

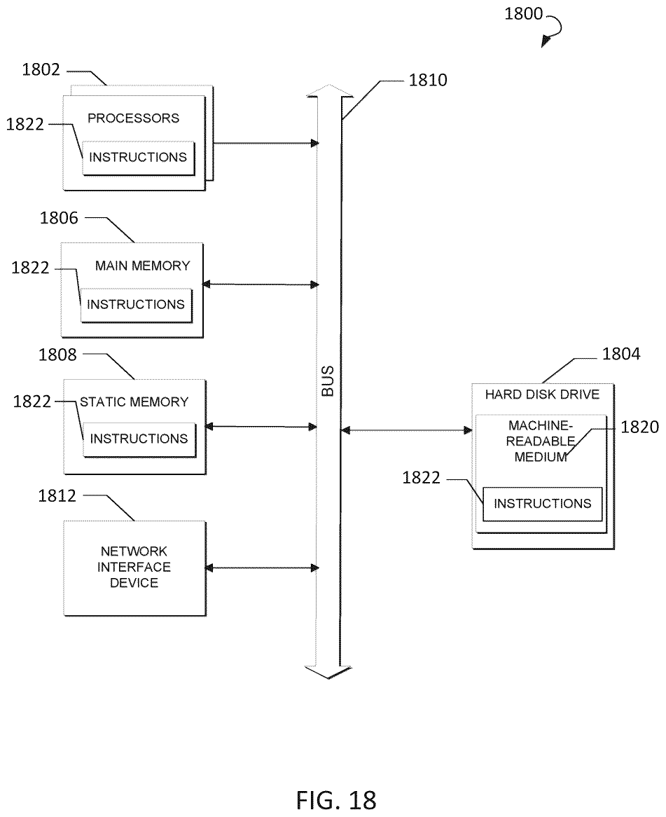

FIG. 18 is a diagrammatic representation of a machine 1800 of the speech recognition system 1700, within which a set of instructions for causing the machine to perform the above-described steps and method can be executed. In various embodiments a local device 1720 of the machine is connected (e.g., networked) to other devices, such as the earbud 1710 and server(s) on the cloud 1730. Thus, in a networked deployment, the machine 1800 can operate in the capacity of a client machine alone or with a server in a server-client network environment, or as a peer machine in a peer-to-peer (or distributed) network environment. Thus, while only a single machine is illustrated, the term “machine” shall also be taken to include any collection of devices (e.g., local device 1720, on board microprocessor 110, server(s) on the cloud 1730) that individually or jointly execute a set (or multiple sets) of instructions to perform any one or more of the methods and/or steps discussed herein.

The machine 1800 includes a processor or multiple processors 1802, a hard disk drive 1804, a main memory 1806, and a static memory 1808, which communicate with each other via a bus 1810. The machine 1800 may also include a network interface device 1812. The hard disk drive 1804 may include a non-transitory computer-readable medium 1820, which stores one or more sets of instructions 1822 for carrying out or executing any of the functions/processes described herein. The instructions 1822 can also reside, completely or at least partially, within the main memory 1806, the static memory 1108, and/or within the processors 1802 during execution thereof by the machine 1800.

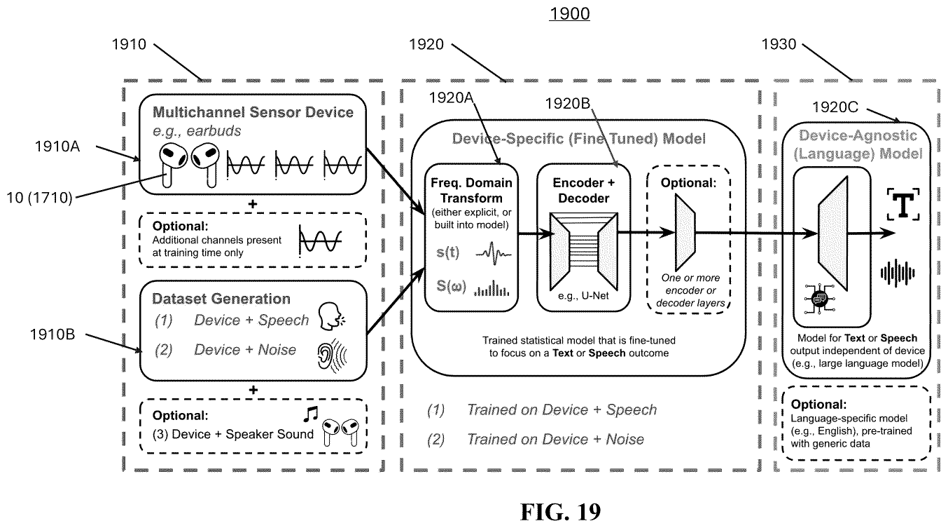

A more detailed description of examples of a speech recognition system according to the present technology will now be described with reference to FIGS. 19-21. Overall, and with reference to FIG. 19, a speech recognition system 1900 according to the present technology includes a device component 1910 for producing a preliminary audio output of sounds captured by the device including speech of the user, and a speech-modeling component 1920 for processing the preliminary audio output to create a fine-tuned model of the preliminary audio output, namely, a denoised signal having a low signal-to-noise ratio (SNR). The speech recognition system may further include a downstream processing component 1930 for converting the denoised signal to humanly perceptible output, which expresses the speech (as text, for example), from the signal having the low SNR.

The device component 1910 comprises a wearable device 1910A, e.g., an earbud 10(1710), having multiple sensors operative to capture sounds including sound conducted through air in an environment in which a user wearing the device is situated and speech of the user conducted through bone of the user to produce, as the preliminary audio output, channels of streams of audio signals predominantly representing environmental sound and bone-conducted speech, respectively. In this example, three channels are shown, which include a channel of a stream of audio signals (predominantly) representing background noise and a channel of a stream of audio signals (predominantly) representing voiced speech. Optionally, the device component has other sensors, e.g., an inertial sensor, for producing another discrete stream of audio signals. The device component 1910 also has a processing unit 1910B that produces a training data from samples of speech and background noise. Optionally, the wearable device has a speaker, as well, in which case the processing unit 1910B also creates the training dataset using sound from the speaker. Although not shown, an off-device sensor may be provided to produce other channels as part of the preliminary audio output, used for purposes of creating the training data only.

The speech-modeling component 1920 produces a processed signal having a higher SNR than the preliminary audio output. To this end, the speech-modeling component 1920 pre-processes the preliminary audio output using a frequency domain transformation algorithm 1920A. Then the speech-modeling component 1920 denoises the frequency-domain features of the preliminary audio output using a neural network 1920B, which has been fine-tuned based on both device-specific data and the training data. As an example, the frequency-domain features comprise magnitude and phase spectra for each channel of the preliminary audio output, computed within a given window of time. The neural network is realized by an encoder-decoder architecture, in which one or more encoder/decoder layers are provided in sequence and/or in parallel. As an example, one or more of the layers of the encoder-decoder architecture is realized as a U-net.

Downstream processing component 1930 provides a device agnostic model to produce transcribed text or a voiced representation of the user's speech from the fine-tuned model output (denoised and compressed signal) by the speech-modeling component 1920. To this end, the downstream processing component 1930 may comprise a speech-to-text model in the case in which the output is transcribed text. The speech-to-text model may be implemented as a decoder. On the other hand, the downstream processing component 1930 may comprise an inverse short-time Fourier Transform in which case the output is a clear voice version of the speech.

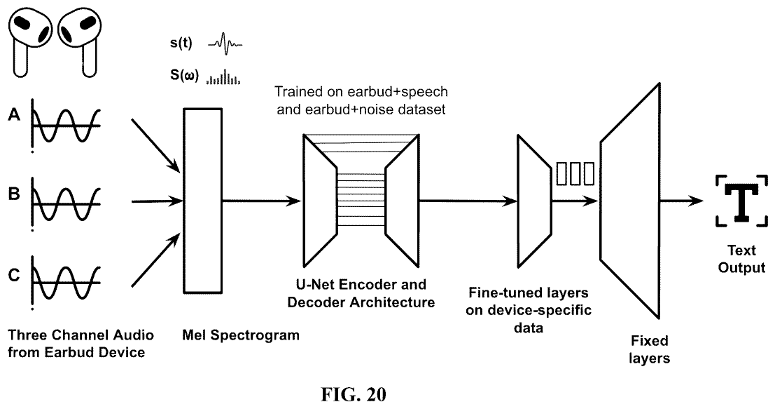

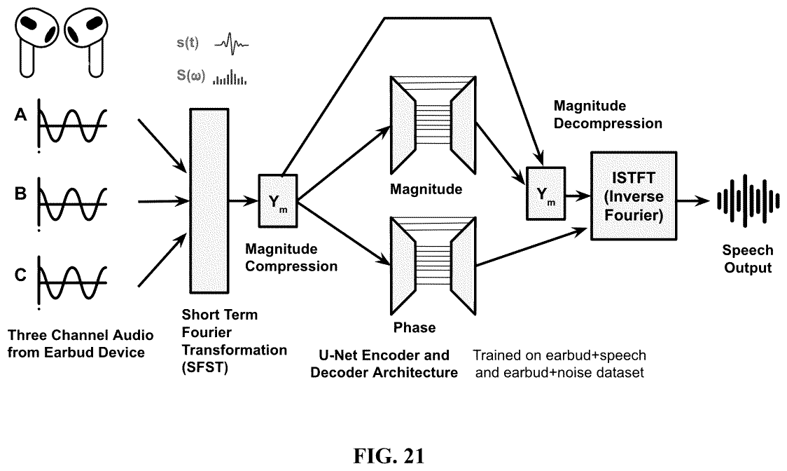

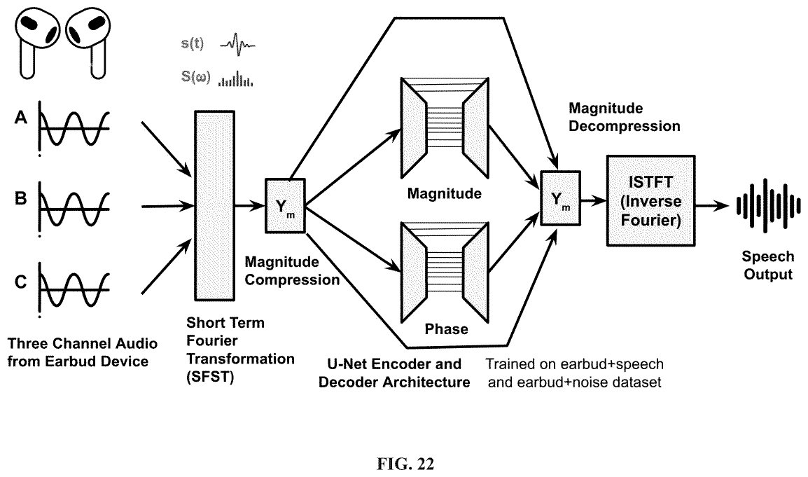

FIG. 20 shows an embodiment in which the speech recognition system of FIG. 19 is adapted to convert speech to text, and FIG. 21 shows an embodiment in which the speech recognition system of FIG. 19 is adapted to convert speech containing significant noise to clear speech. In the system of FIG. 20 a mel spectrogram is used to transform the signal and extract spectral features, a U-net is used as a fine-tuned model to produce a processed speech (denoised) signal, and a speech-to-text model including device-specific fine-tuned layers and pretrained fixed layers produces the text output. In the system of FIG. 21, having a low SNR signal to clear speech pipeline, a short-time Fourier transform (STFT) algorithm is used for pre-processing to result in magnitude and phase features, a U-net encoder decoder architecture is used to produce a processed speech (denoised) signal for the sets of features, and an inverse short-time Fourier transfer algorithm is used to produce the voiced version of the user's speech. Another example of a system having a low SNR signal to clear speech pipeline according to the present technology is shown in FIG. 22. In this system, the phase is processed together with an additional operation.

As is clear from the description above, a true train of thought method or device (AI or virtual assistant) is realized by the present technology. In addition, by capturing and discerning whispered speech using a wearable but innocuous or otherwise unobtrusive device, the present technology can provide one or more of the following advantages: personalizable and private so as to be secure and trusted, and capable of accurate and repeatable performance including with a low latency response time; intuitive and easy to use; and freeing with respect to task augmentation especially from the confines of behind a desk. The present technology also allows for a voice input to a repository and hence, an AI or digital assistant for the augmentation of any number of tasks may be realized according to the present technology.

Finally, although the present technology has been described above in detail with respect to various embodiments and examples thereof, the present technology may be embodied in many other different forms. For example, although a wearable device by which the present technology is realized has been described as an earbud, other unobtrusive or innocuous wearable devices such as a wristband may be employed. Furthermore, and as was mentioned above, although whispered speech has been used as an example of the category of low SNR speech which can be recognized according to the present technology for use in augmenting a task, the present technology may also be applied to voice recognition of other low SNR speech. Thus, the present invention should not be construed as being limited to the embodiments and their examples described above. Rather, these embodiments and examples were described so that this disclosure is thorough, complete, and fully conveys the present invention to those skilled in the art. Thus, the true spirit and scope of the present invention is not limited by the description above.

What is claimed is:

1. A method of discerning and reproducing speech, comprising:
separately capturing sound conducted through air in an environment in which the user is situated, and through bone of a user while the user is speaking to produce, as a preliminary audio output, channels of streams of audio signals, wherein the preliminary audio output has a low signal-to-noise ratio (SNR);
transforming the streams of audio signals constituting the preliminary audio output and extracting features from a resulting transform of the audio signals;
denoising the preliminary audio output to produce a processed signal having a higher SNR than that of the preliminary audio output, the denoising comprising inputting the extracted features to a statistical model or a neural network; and
generating humanly perceptible output, which expresses the speech of the user, from the processed signal.

2. The method as claimed in claim 1, wherein the respective channels are time-synchronized.

3. The method as claimed in claim 1, wherein the capturing of sound conducted through the air comprises separately capturing voiced speech of the user conducted through the air and background noise in the environment, whereby preliminary audio output is constituted by at least three channels of streams of audio signals.

4. The method as claimed in claim 1, wherein the transforming comprises transforming the audio signals constituting the preliminary audio output to a frequency domain representation of the preliminary audio output, and the features extracted are frequency components of the channels.

5. The method as claimed in claim 1, further comprising generating a predetermined audio waveform as part of the preliminary audio output.

6. The method as claimed in claim 5, wherein the denoising comprises inputting the predetermined audio waveform to the statistical model or neural network.

7. The r method as claimed in claim 1, wherein the generating of humanly perceptible output comprises generating text which expresses the user's speech.

8. The method as claimed in claim 1, wherein the generating of humanly perceptible output comprises generating a voiced version of the user's speech.

9. A method of discerning and reproducing speech, comprising:
capturing sounds on multiple sensors of a device worn by a user while the user is speaking, the sounds including sound conducted through air in an environment in which the user is situated and speech of the user conducted through bone of the user to one of the sensors,
wherein the sensors produce, as a preliminary audio output, channels of streams of audio signals, and the preliminary audio output has a low signal-to-noise ratio (SNR);
transforming the streams of audio signals constituting the preliminary audio output and extracting features from a resulting transform of the audio signals;
denoising the preliminary audio output to produce a processed signal having a higher SNR than that of the preliminary audio output, the denoising comprising inputting the extracted features to a statistical model or a neural network; and
generating humanly perceptible output, which expresses the speech of the user, from the processed signal.

10. The speech recognition method as claimed in claim 9, wherein the capturing of sounds comprises capturing voiced speech of the user conducted through the air with a first microphone of the device which is oriented towards the user's mouth, capturing background noise in the environment with a second microphone of the device, and capturing the speech of the user conducted through bone of the user with a third microphone of the device which is acoustically isolated from the environment while pressed up against skin of the user, and wherein the respective audio channels produced include audio signals representing background noise and voiced speech, respectively.

11. The method as claimed in claim 9, wherein the respective channels are time-synchronized.

12. The method as claimed in claim 9, wherein the multichannel audio signal additionally comprises a reference channel which is a drive signal being fed to an audio output device.

13. The method as claimed in claim 9, wherein the transforming comprises transforming the audio signals constituting the preliminary audio output to a frequency domain representation of the preliminary audio output, and the features that are extracted are frequency components of the channels.

14. The method as claimed in claim 9, wherein the denoising comprises producing the processed signal directly in response to the features being input to a trained statistical model.

15. The method as claimed in claim 9, wherein the denoising comprises producing filter parameters to be applied to the preliminary audio output in response to the extracted features being input to a trained statistical model, and filtering the preliminary audio output to produce the processed signal based on at least the filter parameters.

16. The method as claimed in claim 9, wherein the denoising comprises producing magnitude weights and phase shifts to be applied to the extracted features in response to the extracted features being input to a trained statistical model, a reweighting step of applying the magnitude weights and phase shifts to the extracted features to produce reweighted features, and a combining step of combining the reweighted features into a single channel representation to produce the processed signal.

17. A system for use in discerning and reproducing speech, comprising:
multiple sensors constituting a wearable device and operative to capture sounds including sound conducted through air in an environment in which a user wearing the device is situated and speech of the user conducted through bone of the user to one of the sensors to produce, as a preliminary audio output, channels of streams of audio signals, and wherein the preliminary audio output has a low signal-to-noise ratio (SNR); and
a computer system configured to receive the channels of audio signals from the wearable device and comprising a processing unit, and non-transitory computer-readable media (CRM) storing operating instructions,
the processing unit having a denoising module comprising a statistical model or a neural network and configured to execute the operating instructions to:
transform the streams of audio signals constituting the preliminary audio output and extract features from a resulting transform of the audio signals, and
denoise the preliminary audio output to produce a processed signal having a higher SNR than that of the preliminary audio output, the denoising comprising inputting the extracted features to the statistical model or neural network.

18. The system as claimed in claim 17, comprising an earbud as the wearable device, and wherein the multiple sensors include an in-ear microphone occluding an ear canal of the user when the earbud is worn by the user so as to capture speech of the user conducted through bone of the ear of the user, and a second microphone oriented to capture external sound conducted through the air towards the earbud.

19. The system as claimed in claim 17, wherein the processing unit is configured to execute the operating instructions to transform the audio signals constituting the preliminary audio output to a frequency domain representation of the preliminary audio output, and extract frequency components of the channels as said features.

20. The system as claimed in claim 17, wherein the processing unit is configured to execute the operating instructions to further generate humanly perceptible output, which expresses the bone-conducted speech, from the processed signal.
